(19) United States
(12) Patent Application Publication
(10) Pub. No.: US 2024/0034180 A1
(43) Pub. Date: Feb. 1, 2024

(54) METHOD FOR REDUCING CARBON FOOTPRINT LEVERAGING A COST FUNCTION FOR FOCUSED OPTIMIZATION

(71) Applicant: VOLKSWAGEN AKTIENGESELLSCHAFT, Wolfsburg (DE)

(72) Inventors: Mohak BHIMANI, Sunnyvale, CA (US); Ethan BOROSON, Alameda, CA (US); William Arthur PAXTON, Redwood City, CA (US); Maximilian THUM, Foster City, CA (US)

(21) Appl. No.: 17/874,753

(22) Filed: Jul. 27, 2022

(51) Int. Cl. B60L 53/64; B60L 53/62; B60L 53/63; B60L 58/13; B60L 58/16

(52) U.S. Cl. CPC B60L 53/64; B60L 53/62; B60L 53/63; B60L 58/13; B60L 58/16

(57) ABSTRACT

Approaches, techniques, and mechanisms are disclosed for improving carbon footprint of electric vehicles and/or homes. A time window when an electric vehicle connects with a charging station is determined. The charging station is connected with a grid from which the charging station is configured to draw electricity to charge the electric vehicle. An electricity demand of the electric vehicle is predicted based on a current state of charge (SoC) of batteries of the electric vehicle. Costs for drawing electricity from the grid during time intervals are computed. The time window is partitioned into a plurality of time intervals including the time intervals. An optimized schedule for performing operations with the batteries is generated based on the costs. The operations include those used to charge the electric vehicle to satisfy the predicted electricity demand of the electric vehicle.

### CROSS-REFERENCE TO RELATED APPLICATIONS

This application is a Continuation-in-Part of U.S. patent application Ser. No. 17/553,633 filed on Dec. 16, 2021, the contents of all of which are incorporated herein by reference in their entireties.

### TECHNICAL FIELD

Embodiments relate generally to electric vehicles, and, more specifically, to reducing carbon footprint leveraging a cost function for focused optimization.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Demands from electric vehicles (EVs) on electricity grids are growing rapidly as more and more EVs are being made by vehicle manufacturers and used by vehicle owners for daily driving needs. Artificial intelligence (AI) or machine learning (ML) techniques have been developed to achieve better fuel economy or reduce fuel consumption through optimization of limited parameters used in vehicle related operations. For example, some AI/ML techniques may be used in plug-in hybrid electric vehicles (HEVs) to autonomously learn optimal fuel/electricity splits in vehicle propulsion operations from interactions between the vehicles and traffic environments for the purpose of saving fuel.

Electricity grids may provide electricity that is originally generated from a variety of energy source types such as coal, natural gas, wind, solar, hydro, etc. Hence, the grids may use electricity generated from different mixes of fossil fuel, renewable and green energy sources at different time points to satisfy electricity demands some of which are originated from the EVs and/or homes. As a result, the electricity demands from the EVs and/or homes can very well be frequently satisfied by electricity coming from fossil fuel and energy sources other than green energy sources.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1A illustrates an example framework for optimizing carbon footprints relating to electric vehicles; FIG. 1B illustrates an example system for optimizing carbon footprints relating to electric vehicles;

FIG. 2A through FIG. 2C illustrate example optimization of charging schedules;

FIG. 2D illustrates an example display page (or heat map) that visualizes emissions and electricity demands;

FIG. 3A through FIG. 3D illustrate example penalty functions;

FIG. 4 illustrates an example process flow; and

FIG. 5 is block diagram of a computer system upon which embodiments of the disclosure may be implemented.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:
1.0. General Overview
2.0. Structural Overview
   2.1. Electricity Grids
   2.2. Electricity Grid Data Collector
   2.3. Electric Vehicle Data Collector
   2.4. Home Consumption Data Collector
   2.5. Demand and Footprint Prediction Models
   2.6. Demand and Footprint Visualization
   2.7. Charging and Transfer Schedule Generator
3.0. Functional Overview
   3.1. Minimizing Emissions
   3.2. Predicting Demands
   3.3. Predicting Emissions
   3.4. Vehicle Optimization
   3.5. Bidirectional Enerty/Power Transfer
   3.6. Penalty Functions
   3.7. Visualizing Emissions and Demands
4.0. Example Process Flows
5.0. Implementation Mechanism—Hardware Overview
6.0. Extensions and Alternatives

### 1.0. General Overview

Techniques as described herein can be used to improve overall carbon footprints of electricity or energy consumption by electric vehicles and/or homes (e.g., residence buildings, residence houses or apartments or flats, etc.) by building optimization models and leveraging prediction models for energy demand and associated charging behavior. Generally speaking, any form of energy generation has an associated carbon footprint. As used herein, “footprint” or “carbon footprint” may refer to quantities, volumes, weights, etc., of greenhouse gas or carbon dioxide gas emissions as a result of electricity or energy supply or consumption. Example carbon footprints as described herein may, but are not necessarily limited to only, be associated or measured in relation to one or more of: specific electricity grid(s), specific geographic area(s)/location(s), specific vehicle manufacturer(s), specific vehicle model(s), specific home locations, specific combinations of home appliances used in homes, etc. In a non-limiting example, carbon footprints may refer to greenhouse gas or carbon dioxide gas emissions caused by generating electricity to meet electricity demands of a fleet of electric vehicles made by one or more specific vehicle manufacturers and/or homes with which the electric vehicles can be charged or discharged.

The techniques as described herein can be applied in a wide range of operational scenarios to connect the systems used to operate the electricity grids with electricity consumers such as the electric vehicles and/or homes. As a non-limiting example, these techniques can be implemented by a vehicle manufacturer (e.g., VW, Audi, Porsche, etc.) to influence demand, supply, and consumption of energy or electricity by a fleet of electric vehicles made by the vehicle manufacturer and/or by homes with which the electric vehicles can be discharged or charged. Hence, the carbon footprint relating to the fleet of electric vehicles (e.g., hybrid electric vehicles or REV, battery electric vehicles or BEVs, etc.) and/or the homes can be significantly reduced or improved.

Several different energy sources may be combined to make up energy supply from electricity grid(s), resulting in an overall carbon intensity that varies over time. As used herein, “carbon intensity” may refer to physical quantities, volumes, weights, etc., of greenhouse gas emission per unit of electricity supply or consumption and/or per unit (e.g., 10 minutes, 15 minutes, minutes, etc.) of time. As electricity supplies at different time points or intervals may be generated or supplied from different mixes or combinations of energy or electricity source types, carbon intensities—or greenhouse gas or carbon dioxide gas emissions per unit of electricity supply or consumption per unit of time—at these different time points or intervals can be quite different. Additionally, optionally or alternatively, “carbon intensity” may refer to physical quantities, volumes, weights, etc., of greenhouse gas emission per unit of electricity supply or consumption and/or per unit (e.g., 10 minutes, 15 minutes, 20 minutes, etc.) of time related to a particular geographic area or location such as Santa Clara County, the entire northern California region, a collection of geographic areas or locations such as California and Germany in which a fleet of electric vehicles made by a vehicle manufacturer whether underlying electric grids are connected to the same electric power transmission networks or not, general for use cases in larger geographic locations. Hence, carbon intensity as described herein may be measured or determined at various granularity levels of geography from sections or parts of a single electric grid to multiple transnational electric grids.

An insufficiently charged plug-in hybrid electric vehicle is likely to consume fossil fuel in vehicle operations and hence emit greenhouse gas or carbon dioxide gas. While an electric vehicle with sufficient electric power itself emits no or little greenhouse gas or carbon dioxide gas, the electric vehicle may nevertheless consume electricity originally generated from an energy source (or source type) that does cause emissions.

Under the techniques as described herein, a cost function can be used in an optimization method/algorithm for scheduling charging or discharging events of an electric vehicle at a home. The cost function can be specifically specified or built to enable the optimization method/algorithm to operate in several layers or levels each of which can be tailored to specific operational and/or electricity consumption needs. The optimization method/algorithm can include a prediction/forecasting model to schedule charging events (or trigger charging) when the contemporaneous carbon intensity is low and schedule bidirectional energy transfer events, for example to satisfy non-electric-vehicle electricity consumption of a home, when the contemporaneous carbon intensity is high.

Approaches, techniques, and mechanisms are disclosed for improving carbon footprint of electric vehicles and/or homes. A specific time window during which an electric vehicle is connecting with a charging station is determined. The charging station is connected with a grid from which the charging station is configured to draw electricity to charge the electric vehicle. An electricity demand of the electric vehicle is predicted based on a current state of charge (SoC) of one or more batteries of the electric vehicle. One or more costs associated with drawing electricity from the grid during one or more time intervals are computed. The specific time window is partitioned into a plurality of consecutive non-overlapping time intervals that include the one or more time intervals. An optimized schedule for performing a set of operations with the one or more batteries of the electric vehicle is generated based at least in part on the one or more costs. The set of operations include at least a subset of operations used to charge the electric vehicle to satisfy the predicted electricity demand of the electric vehicle.

In other aspects, the disclosure encompasses computer apparatuses and computer-readable media configured to carry out the foregoing techniques.

### 2.0. Structural Overview

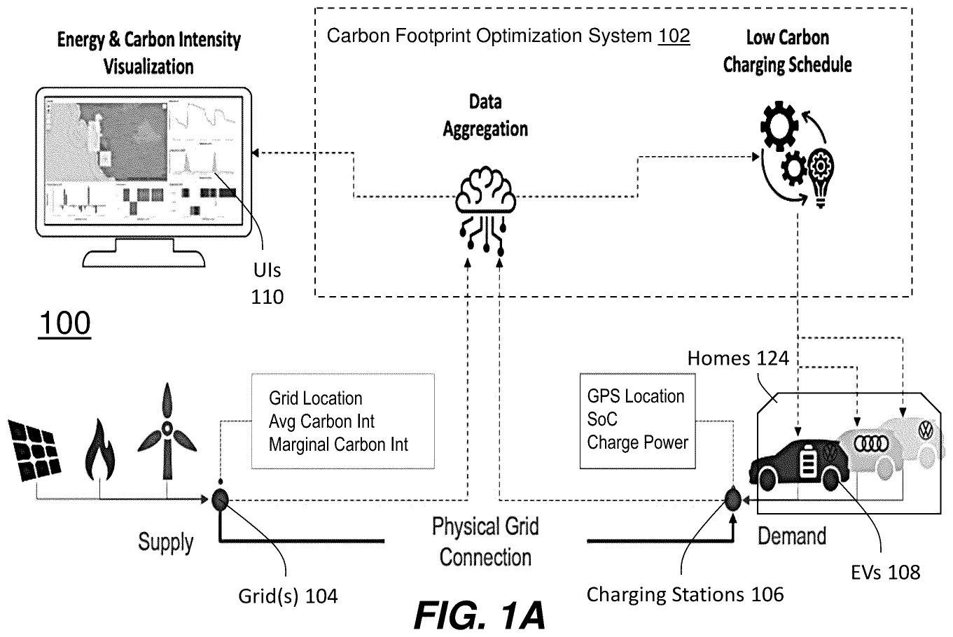

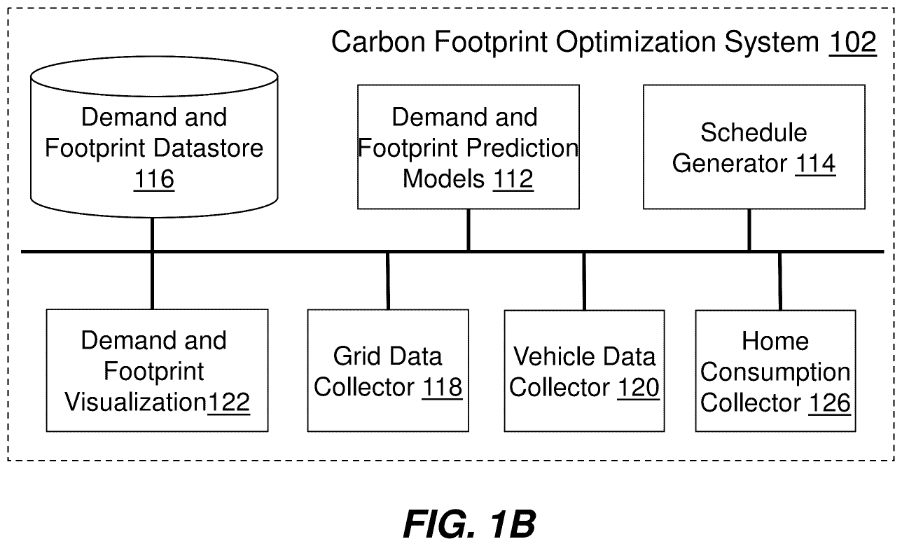

FIG. 1A illustrates an example framework 100 for optimizing carbon footprints relating to electric vehicles (EVs) and/or homes. The framework (100) comprises a carbon footprint optimization system 102, one or more grid(s) 104, (e.g., home-based, etc.) charging stations 106 at individual homes 124, individual EVs 108, UIs 110 for energy and carbon intensity visualization, etc. Also as illustrated in FIG. 1B, in some operational scenarios, the carbon footprint optimization system (102) further comprises demand and emission prediction models 112, an electric vehicle charging and energy/power transfer schedule generator 114, an electricity demand and carbon footprint datastore 116, an electricity grid data collector 118, an electric vehicle data collector 120, an electricity demand and carbon footprint visualization block 122, etc. The system (102) or subsystem(s) therein may be implemented with some or all of: artificial intelligence or AI techniques, machine learning or ML techniques, non-AI non-ML techniques, a combination of different types of computing techniques, etc. Each block, module, device, system, etc., illustrated in the framework (100) and/or the system (102) may be collectively or individually implemented with one or more computing devices that comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

2.1. Electricity Grids

Electricity grids are to comply with needs for electricity and meet demands (e.g., within respective specified service territories, etc.) at respective geographic areas or locations in which the grids are deployed. Example geographic areas or locations may include, but are not necessarily limited to only, grid service areas/districts, villages, towns, cities, counties, states or portions therein, regions, nations, any combinations of the foregoing, etc.

A plurality of green, renewable, non-renewable and/or fossil fuel energy sources (or source types) such as coal, natural gas, wind, solar, hydro, etc., can be utilized by the grids to generate or supply electricity. As used herein, “green energy source” or “green energy source types” refer to energy sources or types whose generation/production causes no or little greenhouse gas or carbon dioxide gas emissions. “Renewable energy source” or “renewable energy source types” refer to energy sources or types that are naturally replenishable, for example over a reasonable time span such as yearly, every few years, etc. Examples of green and renewable energy sources or types are solar or wind. In comparison, “non-renewable energy source” or “non-renewable energy source types” refer to energy sources or types that are not naturally replenishable, for example over a reasonable time span. Examples of non-renewable energy sources or types are various fossil fuels.

Due to dynamic or time varying nature of electricity demands and supplies and intermittent nature of renewable energy sources, it may not always be possible to meet demands with electricity supplies generated with energy from 100% green and/or renewable energy sources. Sometimes, the grids are able to produce more electricity than needed to meet demands using only green and/or renewable resources. The excess energy can be exported to a neighboring grid or can be curtailed. Sometimes, fossil-fuel-based power plants—e.g., peak shaving plants (referred to as Peaker Plants)—are brought online to help meet marginal or average demands when the demands or corresponding loads increase and/or when electricity supplies generated from green and/or renewable sources diminish.

Under other approaches that do not implement techniques as described herein, from the energy or electricity supply side, electricity grids generally do not have a direct influence on energy demand. From the vehicle side, cars with bidirectional energy transfer capability have not been widely developed. Even though there are some cars in production today with bidirectional energy transfer capabilities, these cars have mostly been advertised and used as supplemental power during emergency electricity outage situations and bidirectional energy transfer events are triggered manually or follow a static schedule based on the energy rate (utility charged fee) structure without regard for underlying carbon emission costs. Hence, as the grid side and the demand side operate largely independently of each other, there is currently a lost opportunity to optimize energy usage and minimize greenhouse gas emissions.

In contrast, under techniques as described herein, electricity supplies from the grid(s) (104) and electricity demands from the electric vehicles (108) and/or the homes (124) can be shaped, influenced and/or controlled by the system (102) to work hand in hand to help reach or accomplish a 100% renewable energy portfolio for electricity consumption by the electric vehicles (108) and/or the homes (124).

Users (or vehicle owners or operators) may opt in to using their personal electric vehicles for bidirectional energy/power transfer events. The system (102) can make suggestions of, or schedule, vehicle charging events and bidirectional energy/power transfer events to help realize relatively large cost and emission reduction benefits possible for these users.

The system (102) can implement prediction models to track, predict, and influence electricity demands from the electric vehicles (108) and/or the homes (124) as well as energy supplies provided by the grid(s) (104) from electricity generation and/or electricity storage. These prediction models can operate with optimization models/algorithms—e.g., implemented in the system (102) or one or more subsystems therein—that generate or recommend optimized electricity charging and/or transfer events. Hence, the prediction models implemented in the system (102) can be leveraged with the optimization models/algorithms to generate optimized electricity charging and/or transfer events for the purpose of reducing electricity costs and/or emissions as intended or indicated by the users.

Localized energy demands—including but not limited to individual electricity demands of specific homes (124)—and associated greenhouse gas emissions in various geographic areas or locations in which the grid(s) (104) are deployed or physically connected with the electricity charging stations (106) to supply or draw electricity to or from the electric vehicles (108) can be tracked, predicted, or influenced by triggering or scheduling electric charging and/or discharging events at optimal or optimized times for the electric vehicles (108) and/or the homes (124). Example system(s) for tracking, predicting and/or influencing electricity or energy demand and consumption are described in the previously mentioned U.S. patent application Ser. No. 17/553,633.

2.2. Electricity Grid Data Collector

As shown in FIG. 1B, the system (102) may comprise an electricity grid data collector (118) that interacts with (grid) system(s) used to operate or control the electricity grid(s) (104) for the purpose of collecting grid data relating to the electricity grid(s) (104). The system (102) can be operationally or communicatively linked with the grid system(s) via one or more first data communication network connections over one or more first computer networks. The first data communication network connections can be supported or implemented with any combination of a wide variety of communication techniques including but not limited to those related to cellular communications, wire-based communications, wireless communications, optical communications, ethernet communications, etc.

Example grid data as described herein may include, but are not necessarily limited to only, some or all of: grid location(s), average carbon intensities, marginal carbon intensities, etc., of the electricity grid(s) (104). Additionally, optionally or alternatively, the grid data may include other grid data types such as source types of energy supply and production at each of some or all of the grid(s) (104), available transmission capacity used to satisfy electricity demands at each of some or all of the grid(s) (104), dynamic or estimated energy demands from consumers including but not limited to those related to the electric vehicles (108) at each of some or all of the grid(s) (104), available energy storage for electricity flowing to or from the grid(s) (104) at each of some or all of the grid(s) (104), etc. In some operational scenarios, additional grid data may be derived or computed from the collected grid data, for example by the system (102) or by an attendant system/device such as an aggregation node operating in conjunction with the system (102).

The collected grid data from the electricity grid(s) (104) (and/or the additional grid data if any) may be provided by the grid data collector (118) to other blocks or modules in the system (200). Additionally, optionally or alternatively, the grid data can be stored in, and managed or accessed through, the electricity demand and carbon footprint datastore (116).

2.3. Electric Vehicle Data Collector

As shown in FIG. 1B, the system (102) may comprise an electric vehicle data collector 120 that interacts with system(s) (not shown) used to operate the electric vehicle charging stations (106) and/or the electric vehicles (108) for the purpose of collecting vehicle data relating to the electric vehicles (108). The system (102) can be operationally or communicatively linked with the electric vehicle charging stations (106) and/or the electric vehicles (108) (or vehicle batter managements systems therein) via one or more second data communication network connections over one or more second computer networks. The second data communication network connections can be supported or implemented with any combination of a wide variety of communication techniques including but not limited to those related to cellular communications, wire-based communications, wireless communications, optical communications, ethernet communications, etc.

Example vehicle data may include, but are not necessarily limited to only, some or all of: geographic positioning system (GPS) generated locations, outputs from battery management systems deployed in or with electric vehicles, charging and/or bidirectional energy/power transfer capabilities of the electric vehicles, individual and/or overall states of charge (SoCs) of batteries and/or battery modules/packs in the electric vehicles, individual and/or overall (e.g., latent, history-dependent, age-dependent, use-dependent, dynamic, adjusted to aging, etc.) states of health (SoHs) of the batteries and/or battery modules/packs, current and/or past operational temperatures of the batteries and/or battery modules/packs, current and/or past operational voltages provided by the batteries and/or battery modules/packs, (e.g., percentage charged, full, etc.) charge powers of the batteries and/or battery modules/packs, user input from interacting with drivers or owners of the electric vehicles (108, etc., of the electric vehicles (108), and so on. In some operational scenarios, operational temperatures of the batteries of the electric vehicle as measured or outputted by a battery management system (e.g., in the electric vehicle, etc.) may be used as a part of (input) keys or index values or battery states to look up or determine specific penalty values from a penalty plot/function/curve. The penalty plot/function/curve may be represented as a multi-dimensional (look-up) table, which may be developed or specified before battery operations described herein, or dynamically updatable while the batteries are deployed in the field.

The collected vehicle data in connection with the electric vehicles (108) may be provided by the vehicle data collector (120) to other blocks or modules in the system (200). Additionally, optionally or alternatively, the vehicle data can be stored in or accessed through the electricity demand and carbon footprint datastore (116).

In addition to using the collected vehicle data to effectuate electricity charging of electric vehicles when the grids are using clean or green energy sources with no or little green house or carbon emissions, the system (102) can use the collected vehicle data to identify specific electric vehicles with bidirectional energy/power transfer capabilities and treat these electric vehicles as a source of energy to effectuate supplying electricity to homes with charging stations (or chargers) to which these electric vehicles are connected for charging or for vehicle-to-home energy transfer when the grids are using non-clean or non-green energy sources with relatively large green house or carbon emissions.

2.4. Home Consumption Data Collector

As shown in FIG. 1B, the system (102) may comprise a home (electricity) consumption data collector 126 that interacts with system(s) (not shown) used to monitor electricity consumption of the homes (124) (or a subset of the homes (124) that supports bidirectional energy transfer from respective electric vehicles) for the purpose of collecting home electricity consumption data relating to these homes (124). The system (102) can be operationally or communicatively linked with the homes (124) via one or more third data communication network connections over one or more third computer networks. The third data communication network connections can be supported or implemented with any combination of a wide variety of communication techniques including but not limited to those related to cellular communications, wire-based communications, wireless communications, optical communications, ethernet communications, etc.

Example home electricity consumption data may include, but are not necessarily limited to only, some or all of: geographic positioning system (GPS) generated locations, outputs from electricity consumption monitoring systems deployed in the homes (124), bidirectional energy/power transfer capabilities of the homes (124), etc.

The collected home electricity consumption data in connection with the homes (124) may be provided by the home consumption data collector (126) to other blocks or modules in the system (200). Additionally, optionally or alternatively, the home electricity consumption data can be stored in or accessed through the electricity demand and carbon footprint datastore (116).

2.5. Demand and Footprint Prediction Models

As shown in FIG. 1B, the system (102) may comprise one or more demand and emission prediction models (112) to use the grid data, vehicle data and home (electricity consumption) data as raw data or input for predicting demands and emissions.

To achieve minimized emissions associated with electric vehicles and/or homes, the prediction/forecast models (112) can be trained and used to make predictions for both emissions per unit amount of energy produced at any given time and the total energy demand at the time. Greenhouse gas or carbon gas emission data and electric energy demands (or patterns thereof) relating to electric vehicles and/or homes can be used to train or build the prediction/forecast models (112) in a model training phase. Operational parameters in the prediction/forecast models (112) such as weights or biases used with neuron activation functions of neural nets can be optimized by minimizing prediction/forecast errors of the prediction/forecast models (112). These prediction/forecast errors can be measured or determined in relation to labels or ground truths in training data base at least in part on objective functions, error functions, distance functions, penalty functions, etc., and back propagated to update the weights or biases of the neural nets.

In a model application or deployment phase, the prediction/forecast models (112) with the optimized operational parameters can extract input features of the same types used in the model training phase and use the input features as input (e.g., input neurons, etc.) to generate predictions/forecasts of electricity demands and emissions at grid and/or vehicle levels and/or home levels. These predictions/forecasts from the prediction/forecast models (112) can be used to setup, trigger or schedule optimized electric vehicle charging and/or bidirectional energy/power transfer events—e.g., automatically under permissions of drivers or owners of the electric vehicles (108 of FIG. 1A) and/or the homes (124 of FIG. 1A)—to maximize charging or re-charging (without incurring wasted recharged energy as will be further explained in detail later) of the electric vehicles (108 of FIG. 1A) at time points or intervals of relatively low emissions associated with electricity production or supply, to minimize charging or re-charging of the electric vehicles (108 of FIG. 1A) at time points or intervals of relatively high emissions associated with electricity production or supply, and/or to minimize (non-vehicle) electricity consumption of the grids by the homes (124 of FIG. 1A) at time points or intervals of relatively high emissions associated with electricity production or supply. Hence, the electric vehicles (108 of FIG. 1A) can be charged with energy that is as green as possible within the specification or indication of users/consumers. Additionally, optionally or alternatively, the homes (124 of FIG. 1A) can consume energy transferred from the electric vehicles (108 of FIG. 1A) when energy supplied from the grids would entail relatively high green house or carbon emission.

2.6. Demand and Footprint Visualization

The system (102) comprises a demand and footprint visualization block (122 of FIG. 1B) visually present or display raw and/or processed demand and emission data including but not limited to report and trend data on the UIs (110) to electricity grid operators and/or human drivers or owners of the electric vehicles, for the purpose of planning, forecasting and/or optimizing electricity generation or supply of the electric grids and usages and operations of the electric vehicles. As used herein, “drivers” or “owners” of the electric vehicles may refer to (e.g., human, business entity, non-business entity, etc.) users or customers who own, operate or use the electric vehicles, and who subscribe to electricity/utility services provided by operators of the electricity grid(s) to meet demands of the electric vehicles for electricity. “Users” or “consumers” may also refer to residents, occupants, renters or owner of the homes at which the electric vehicles are connected to chargers or charging stations for electricity charging with energy supplied by the grids and/or for bidirectional energy/power transfers to the homes.

In an example, the grid data can be used as a part of the input to derive or generate electricity demand and/or carbon footprint display pages to be used in, or rendered on the UIs (110), by the electricity demand and carbon footprint visualization block (122). In another example, the vehicle data can be used as a part of the input to derive or generate electricity demand and/or carbon footprint display pages to be used in, or rendered on the UIs (110), by the electricity demand and carbon footprint visualization block (122). In another example, the home data can be used as a part of the input to derive or generate electricity demand and/or carbon footprint display pages to be used in, or rendered on the UIs (110), by the electricity demand and carbon footprint visualization block (122).

2.7. Charging and Transfer Schedule Generator

As shown in FIG. 1B, the system (102) may comprise a charging and transfer schedule generator (114) to schedule, concentrate, consolidate and/or optimize electricity charging and/or bidirectional energy/power transfer events for some or all of the electric vehicles (108 of FIG. 1A). For example, the schedule generator (114) may fit or adjust charging and/or transfer durations for some electric vehicles and/or homes within relatively large available charging time durations before these electric vehicles resume driving operations and/or transfers energy/power to the homes, when drivers/owners of these electric vehicles have provided permissions to the system (102) to schedule charging and/or transfer events. Specific portions or intervals within the available charging and/or transfer time may be used by the schedule generator (114) to meet electric energy demands of the electric vehicles and/or homes such that greenhouse gas or carbon gas emissions associated with these charging and/or transfer events are minimized.

In some operational scenarios, the system (102) is a non-distributed system implemented with one or more (e.g., cloud based, remote to or outside of electric vehicles, etc.) computing devices in a single location. Additionally, optionally or alternatively, the system (102) may be a distributed system implemented with multiple (e.g., cloud based, remote or outside of electric vehicles, in electric vehicles, etc.) computing devices spanning or distributed across multiple locations. These computing devices may be connected with wireless network or data connections, wired network or data connections, a combination of wired or wireless connections, etc. Hence, the system (102) can operate in different configurations.

Algorithms or process flows implemented in the system (102) can run centrally or distributed. Some algorithms or process flows may be performed with in-vehicle devices/modules of the system (102).

In an example, multiple instances of the schedule generators may be respectively deployed in vehicle with the electric vehicles (108). Each instance in the multiple instances of the schedule generators may be used to schedule and/or optimize charging events for a corresponding electric vehicle in which the instance is deployed.

In another example, multiple in-vehicle or in-charging-station schedule client-side optimizers or agents may be respectively deployed in vehicle with the electric vehicles (108). Each client-side optimizer or agent may operate with the (remote located or cloud-based) schedule generator (114) to schedule and/or optimize charging events for a corresponding electric vehicle in which the client-side optimizer or agent is deployed.

### 3.0. Functional Overview

In an embodiment, some or all techniques and/or methods described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

3.1. Minimizing Emissions

The system (102 of FIG. 1A or FIG. 1B) can be used to solve the emission reduction problem as a relatively simple data-driven (or data-based) problem rather than as a complex modeling problem of human demands. More specifically, the system (102) may be driven, for example entirely with no or minimal user input in real time or near real time operations, by collected raw data. As a result, in some operational scenarios, the system (102) can operate relatively efficiently without needing to determine or know specifically how humans may act in response to various suggestions for preventing or reducing emissions.

The system (102) closes a communication loop, or forms a bridge, between the grid(s) (104), the electric vehicles (108) and/or the homes (124). In addition to vehicle-related data collected from the electric vehicles (108) and/or the (e.g., in-home, in-office, commercial, etc.) charging stations and/or home-related data collected from electricity consumption monitoring systems in the homes (124), the system also collects grid data relating to the electric grid(s) (104). The collected grid data may include, but are not necessarily limited to only, data regarding multiple underlying systems involved in generating, producing, storing and distributing energy or electricity to the electric vehicles (104) or consumer devices other than (plug-in) electric vehicles or hybrid electric vehicles. The system (102) can leverage the bridge or the communication loop or the collected raw data to optimize carbon footprint associated with operations of the electric vehicles (108). The prediction (or forecast) models (112) built in with the system (102) can operate to use the raw data collected from the systems used to operate the grid(s) (104), the charging stations (106), the electric vehicles (108), and/or the homes (124), to generate estimations of demands for electricity and emissions of these demands as well as other demands (not for the electric vehicles (108)) for electricity. These predictions or estimations of electricity demands and emissions from prediction/forecast models (112) in the system (102) may include, but are not necessarily limited to only, some or all of: current day demands of the electric vehicles (108), upcoming week's forecast demands of the electric vehicles (108), past, present and future emissions associated with charging the electric vehicles (108), current day demands of the homes (124), upcoming week's forecast demands of the homes (124), past, present and future emissions associated with electricity consumption of the homes (124), etc. The system (102) can use these estimations to plan or schedule relatively smart/green charging and/or bidirectional energy/power transfer events for the electric vehicles (108) and/or the homes (124) and influence charging and transfer patterns in connection with electricity demands or consumptions of the electric vehicles (108) and/or the homes (124).

For example, in some operational scenarios, the system (102) can be used to enable a relatively large vehicle manufacturer (e.g., VW, Audi, Porsche, etc.) to respond to, influence and reshape dynamic or time varying demands for electricity from a relatively large population of electric or electrified vehicles made by the manufacturer and/or from homes hosting these vehicles to result in an added demand flexibility for minimizing emissions. More specifically, the demand flexibility enabled with the system (102) can be exploited to minimize greenhouse gas emission or carbon footprint associated with operations of the electric vehicles and electricity consumption of the homes, for example through optimizing charging and/or energy/power transfer schedules in connection with the electric vehicles and/or the homes (124).

The vehicle charging and energy/power transfer schedule generator (114) in the system (102) may implement a process flow or algorithm for generating optimized charging, recharging and/or bidirectional energy/power transfer events or schedules for an electric vehicle and/or an home at which the electric vehicle is connected to a charging station. In some operational scenarios, the process flow or algorithm may be in part or in whole performed by an instance or portion of the schedule generator (114) of the system (102) implemented by one or more computing devices in an electric vehicle. Some or all of the process flow or algorithm can be performed in vehicle to set up a specific charging, recharging or bidirectional energy/power transfer event with a selection of a specific optimized time or interval to charge, recharge, or effectuate a bidirectional energy/power transfer to home from, the electric vehicle. The process flow or algorithm can access the demand and footprint prediction models (112) to determine, or generate an estimation of, expected or forecasted demand of the electric vehicle and/or the home for electricity, energy or power until the next charging session or event for the electric vehicle. The process flow or algorithm can also determine the time that the electric vehicle needs to be ready to leave by, for example based at least in part on user input received from the driver or owner of the vehicle; and identify or determine a plurality of candidate or potential time blocks for charging, recharging, or effectuate a bidirectional energy/power transfer to home from, the electric vehicle before that time. The process flow or algorithm can access the demand and footprint prediction models (112) to determine, or generate an estimation of, emissions or emission savings associated with charging, recharging, or transferring electricity from, the electric vehicle in each of the candidate or potential time blocks and select a specific candidate or potential time block with the lowest emissions—as the specific optimized time or interval to charge, recharge, or transfer electricity from, the electric vehicle—from among the plurality of candidate time blocks.

Most drivers charge their electric vehicles when they return home from work or schedule an overnight charge when electricity is not subject to peak pricing. While the electricity may be cheaper, producing the electricity during these hours may generate significant greenhouse gas or carbon gas emissions, for example in a grid that relies heavily on solar power such as in California.

Instead of charging electric vehicles that may well inadvertently induce relatively high emission costs, the system (102) as described herein can be used to provide a user or owner of an electric vehicle and/or a home at which the electric vehicle is charged with a better option to minimize carbon impacts of owning and driving the electric vehicle and/or consuming electricity at the home. For example, the system (102) can cause the electric vehicle to be charged and/or recharged for bidirectional energy/power transfer during specific daytime hours (if possible) when utility cost for electricity is still cheap, but as the sun is up, the electricity can be generated using solar energy that prevents or reduces greenhouse gas or carbon gas emissions across the grid used to charge and/or recharge the electric vehicle for vehicle operations and/or home electricity consumption.

By way of illustration but not limitation, a driver of an electric vehicle may return home from work nightly around 7 PM and leave for work the next day at 9 AM. In order to maintain the appropriate level of charge for usage throughout the day, the vehicle needs to charge for two (2) hours before the driver leaves for work in the morning. Without a charging strategy optimized by the system (102), the vehicle would be charged using relatively dirty energy, from 7-9 PM or overnight. Under techniques as described herein, the system (102) can cause the vehicle to be charged during 7-9 AM the next day instead of the evening or overnight hours. Additionally, bidirectional energy/power transfer capabilities of the electric vehicles can be exploited to effectuate electricity transfers from the electric vehicles when emissions are relatively high and to charge or recharge the electric vehicles when emissions are relatively low. As a result, greenhouse gas or carbon gas emissions associated with charging the vehicle can be significantly reduced. The change of time for charging the vehicle may well reduce emissions from this charging event by 50% or more as compared with the evening or overnight hours.

This saving of emissions can be multiplied across some or all of the electric vehicles (108) and/or the homes (124), which can lead to a significant reduction in greenhouse gas or carbon gas emissions generated by charging numerous electric vehicles and/or consuming electricity by numerous homes worldwide.

3.2. Predicting Demands

The system (102) or the electricity demand and carbon prediction models (112) therein can be used to extract input features from raw data (or history data) collected from the grid(s) (104), the electric vehicles (108), weather information sources, etc., and use these input features to generate estimations, predictions or forecasts of current or future electricity demands at various levels such as global, regional, grid, local and/or vehicle levels. Example input features may include, but are not necessarily limited to only, some or all of: individual and/or overall daily trends, seasonal trends, local/global factors, activities impacting driving, and/or location based weather and climate having influences on electricity or energy demands at the grid level for specific or individual local areas, cities, states, and so on. For example, daylight saving hour changes may globally affect electricity or energy demands and/or production in connection with electric vehicles or grids. Likewise, seasonal weather changes may globally affect carbon intensity as available solar energy may change from season to season. Activities or events such as games, concerts, popular outdoor activities, etc., can also influence people to go to certain areas.

While the trends or factors represented in the input features may influence or relate to the electricity demands in a complex, multi-variate, non-linear way, the prediction models (112)—e.g., deep learning neural nets, etc.—can be used to learn and capture the complex influences the trends or factors depend on—or the multi-variate, non-linear relationships between the trends/factors and the electricity demands—through optimizations of model operational parameters to minimize errors between predictions and ground truths in a model training phase and generate relatively accurate estimations, predictions or forecasts of electricity demands at a given level such as the grid level in a model deployment or application phase.

Electricity demands (from electric vehicles and/or non-electric vehicle electricity or energy consumers) as predicted by the prediction models (112) for some or all of the various levels can be used to determine, or gain an understanding of, individual and/or overall electricity demands associated with or generated by the electric vehicles (108) and/or the homes (124). For example, vehicle specific or vehicle model specific electricity demand and/or electricity demand trends and/or home specific electricity demand and/or electricity demand trends relating to hourly demands or demand trends, daily demands or demand trends, weekly demands or demand trends, etc., can be determined and/or predicted by the system (102) or the prediction models (112) therein.

In addition, relatively accurate information represented by these determined and/or predicted demands and demand trends can be combined with vehicle specific or vehicle model specific information battery system information to determine available charge time or durations associated with each of some or all of the electric vehicles (108) to ensure the vehicle to be charged to a corresponding or appropriate level or state of charge that satisfy specific determined or predicted electricity demands of the vehicle over various lengths of time such as next few hours, for the day, for the week, etc., until the next charging event.

For example, in some operational scenarios, the system (102) or the prediction models (112) therein can look or predict electricity demands of a customer's electric vehicle and/or home for the rest of day today and/or tomorrow. Additionally, optionally or alternatively, the system (102) or the prediction models (112) therein can look or predict electricity demands of the customer's electric vehicle and/or home beyond today or tomorrow and also look at electricity demands in a longer time window such as the next week. The system (102) may schedule charging, recharging or electricity transfer events for the customer's electric vehicle and/or home so that there is no need to charge or recharge the electric vehicle on Thursday as the electric vehicle may not be at its charging station at home on that day. The charging, recharging and/or energy transfer events scheduled by the system (102) may allow or add more energy/electricity/power beyond immediate needs to the electric vehicle for it to operate until the next Monday when the next charging, recharging or energy transfer event can be scheduled.

Additionally, optionally or alternatively, the system (102) or the prediction models (112) therein may schedule the charging and recharging events to specific times when relatively clean energy production is predicted or forecasted to be online in the next few days, and/or schedule the electricity transfer events from the electric vehicle to the home to specific times when relatively dirty energy production is predicted or forecasted to be online in the next few days, for the purpose of reducing individual or overall carbon footprint of electric vehicles. For example, the system (102) can incorporate weather information to determine that a relatively large amount of electricity may be produced from solar energy sources at specific times and steer or select charging or recharging schedules for electric vehicles with a relatively large charging time windows to these specific times to minimize emissions associated with charging or recharging these electric vehicles.

Hence, the optimized charging events can be generated depending on electricity supply/capacity forecasts for the electric grid(s), emissions (e.g., whether the electricity is from green energy source(s) or not, etc.) and individual available charging time window forecasts made for the electric vehicles and/or the homes. A forecast of an individual available charging, recharging or electricity transfer time window for an individual electric vehicle or an individual home at which the electric vehicle accesses a charging station (or device) can vary depending on how much a charging duration (e.g., during which the electric vehicle is connected to draw electricity from the grid(s) or a charging station, etc.) is needed for charging or recharging the vehicle to the maximum level or a level based on the electric vehicle's electricity usage pattern and/or the home's electricity usage pattern. Dynamic vehicle information such as the state of charge (or charge capacity) of the electric vehicle, dynamic home information such as predicted or actual electricity consumption of the home, and forecasted electric vehicle and/or home electricity demand for the rest of day today, tomorrow, within week, etc., can be collected or determined by the system (102) to estimate or predict the time duration for charging, recharging or electricity transferring. The system (102) can allocate the time duration specific times, within the available time window, for charging or recharging when emissions from electricity production/supply is the lowest or relatively low as compared with other times in the available charging time, and for electricity transferring when emission from electricity production/supply is the highest or relatively high. As used herein, “available time,” “available time window” or “specific time window” may refer to a time window formed by a single contiguous time duration or interval; or alternatively may refer to a time window formed by two or more contiguous time durations or intervals, separated by intermediate time durations or intervals (not a part of the “available time,” “available time window” or “specific time window”). In some operational scenarios, these intermediate time durations or intervals may be high emission time durations or intervals during which electricity provided from the grid incurs relatively high greenhouse or CO2 gas emission.

3.3. Predicting Emissions

The system (102) or the electricity demand and carbon prediction models (112) therein can be used to extract input features from the collected raw data as well as estimations or forecasts of electricity demands predicted by the one or more demand prediction models, and use these input features to generate estimations, predictions or forecasts of current or future rate of emissions, average carbon intensities, marginal carbon intensities, etc., at various levels such as global, regional, grid, local and/or vehicle levels. “Average carbon intensities” may refer to carbon intensities derived from averaging source type specific carbon intensities of all energy sources used to generate electricity. Additionally, optionally or alternatively, “average carbon intensities” may refer to carbon intensities derived from averaging carbon intensities incurred from generating all (provided) electricity. “Marginal carbon intensities” may refer to the rate at which carbon intensities would change by increasing or decreasing the electricity demand. Some of the input features used to generate predictions of the current or future rate of emissions, average carbon intensities, marginal carbon intensities, etc., may relate to history data of portions and/or amounts of energy or electricity from different energy source types, average carbon intensities for these energy source types, etc., used to satisfy past electricity demands. Additionally, optionally or alternatively, the input features may include past, current or future electricity demands determined or predicted at the various levels. Additionally, optionally or alternatively, the input features may include some or all of the same or similar trends having influences on electricity or energy demands, as previously discussed, at the grid level for specific or individual local areas, cities, states, electric vehicles, homes, and so on.

The predicted rate of emissions, average carbon intensities, marginal carbon intensities, etc., can be used by the prediction models (112) to track (e.g., in real time, in near real time, etc.), estimate or predict current or future emissions associated with electricity generation or supply by each of some or all of the grid(s) (104) to satisfy current or future electricity demands from each vehicle of some or all of the electric vehicles (108) predicted or estimated for a time duration starting from the present time (e.g., until the next charging event, until 9 am the next day, in next 6 hours, etc.). Additionally, optionally or alternatively, the predicted rate of emissions, average carbon intensities, marginal carbon intensities, etc., can be used by the prediction models (112) to track (e.g., in real time, in near real time, etc.), estimate or predict current or future savings of emissions associated with optimizing charging events to satisfy current or future electricity demands from each vehicle of some or all of the electric vehicles (108) predicted or estimated for a time duration starting from the present time (e.g., until the next charging event, until 9 am the next day, in next 6 hours, etc.) and/or from each home among the homes (124) that is corresponding to the vehicle.

3.4. Vehicle Optimization

In various operational scenarios, carbon footprint optimization can be supported by the system (102) at multiple different levels or layers. For example, the carbon footprint optimization system (102) can use vehicle batteries from the electric vehicles (108) to cover for (e.g., only, substantially all, greater than 99%, etc.) vehicle electricity demands as and when needed in by the electric vehicles (108). The system (102) can implement optimization algorithms, methods and/or models to generate predictions of vehicle electricity demands and predictions of electricity demands and emissions at other levels such as grid or locality level and use these predictions to set up relatively smart schedules for charging the vehicle batteries for the purpose of reducing carbon footprint associated with operating these electric vehicles.

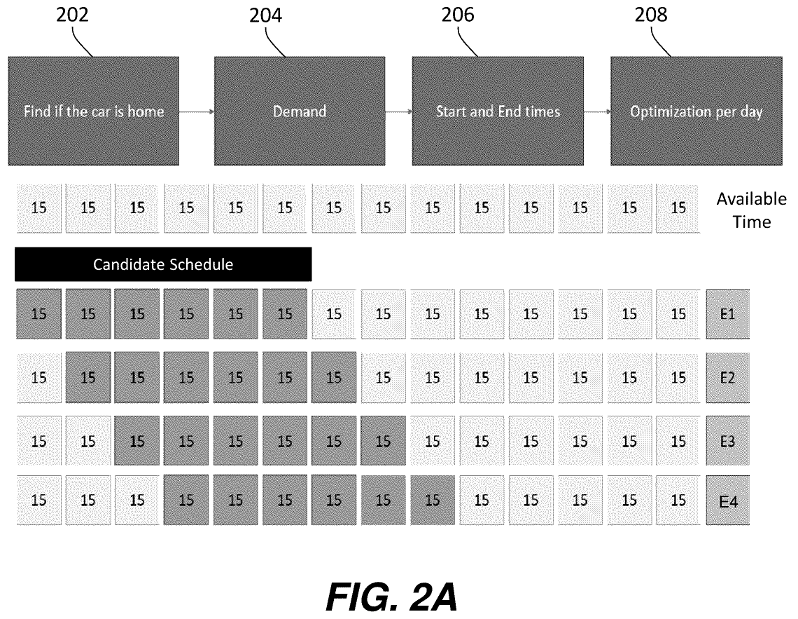

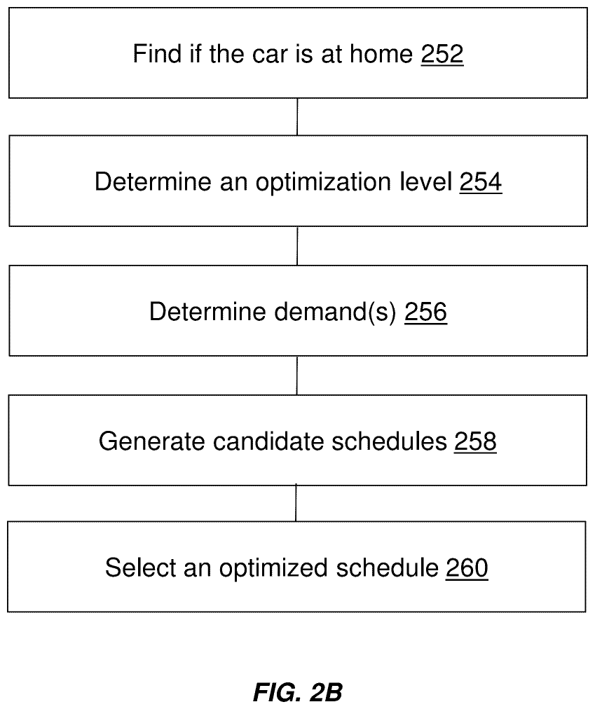

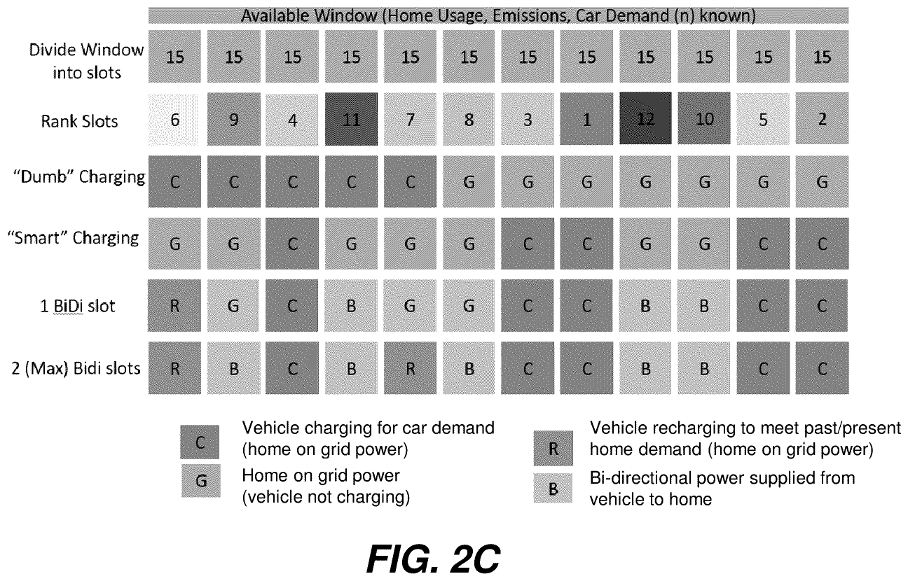

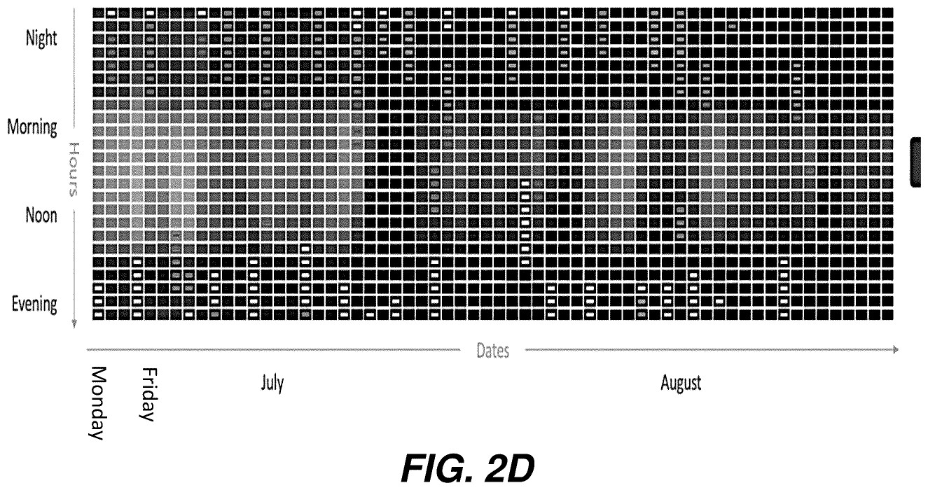

FIG. 2A illustrates example optimization of charging schedules for meeting electricity demands of an electric vehicle. In block 202, the system (102) or a schedule generator therein determines that the electric vehicle is (e.g., electrically, communicatively, etc.) connected to a charger or charging station at a home (or a dwelling/building). The schedule generator may be remote or local to the electric vehicle or the charging station at the home.

The system (102) or the electricity demand and carbon prediction models (112) therein can include one or more grid or locality level dynamic or static prediction models for determining or predicting estimations or forecasts of current or future utility rates for electricity and/or current or future emissions (e.g., rate of emission, carbon intensity, etc.) associated with producing electricity by a grid or in a locality where the electric vehicle can draw electricity from the charging station connected to the grid at the home. In addition, the system (102) or the electricity demand and carbon prediction models (112) therein can include one or more personalized prediction models for determining or predicting personalized usage patterns associated with the electric vehicle. Some or all of these prediction models can be trained dynamically and/or beforehand to use input features extracted from training data (e.g., with labels or ground truths, etc.).

In response to determining—e.g., based on user input, based on estimation of available time, etc.—that the electric vehicle is to be charged immediately as the available time for charging is relatively short or inflexible, the system may operate to cause the electric vehicle to be charged immediately.

On the other hand, in response to determining—e.g., based on user input, based on estimation of the available time, etc.—that the electric vehicle does not have to be charged immediately as the available time for charging is relatively long or flexible, in block 204, the system (102) can select or identify the electric vehicle for charging event optimization. The system (102) can proceed to predict, identify or determine the available time as a specific time window to act as a (e.g., primary, constraining, etc.) placeholder for optimization. The specific time window represents a time duration during which the vehicle can be charged through the charging station at the home. The system (102) can further determine the specific electricity demand of the electric vehicle along with applicable grid or locality level utility rates for electricity and estimated or forecasted emissions associated with producing electricity in the specific time window. With all this information the schedule generator or an optimization algorithm/method used thereby starts optimizing for deriving a relatively smart schedule for charging the electric vehicle in the available time.

In block 206, the system (102) generates a plurality of candidate charging schedules, each of which begins at a respective start time and finishes at a respective end time within the specific time window. As illustrated in FIG. 2A, the specific time window or available time may be divided with a number of non-overlapping consecutive (e.g., 15-minute, etc.) intervals or time blocks. By way of example but not limitation, based on a specific electricity demand of the electric vehicle as determined by the schedule generator, the electric vehicle has one and one half (1½) hours of electricity charging demand, corresponding to six (6) 15-minute intervals or time blocks. The schedule generator or an optimization algorithm/method used thereby may determine the specific electricity demand of the electric vehicle by predicting vehicle electricity usages to be expected for the following day before returning home or until the next charging event as well as when the electric vehicle is supposed to be ready for the next drive.

To generate these candidate schedules or specific candidate start and end times delineating the schedules respectively, the optimization algorithm can start searching, or fitting the candidate schedules in, a (e.g., 1D, 3D, etc.) space such as the specific time window that starts with the first possible opportunity of charging and ends with the cutoff beyond which no charging is to be scheduled.

In block 208, the system (102) selects a specific candidate charging schedule from among the plurality of candidate charging schedules as an optimized charging schedule for the electric vehicle within the specific time window. The optimization algorithm can simulate the entire vehicle charge for each of the candidate charging schedules, compute or determine a respective emission associated with each such candidate charging schedule, compute or determine a respective utility cost or fee associated with each such candidate charging schedule, and so forth. Some or all of individual emissions and utility costs or fees respectively associated with the candidate charging schedules can be saved or cached in memory for comparison. The specific candidate charging schedule may correspond to a relatively low emission such as the lowest emission and/or a relatively low utility cost or fee such as the lowest utility cost or fee among a plurality of computed emissions and/or utility costs/fees respectively associated with the plurality of candidate charging schedules.

As illustrated in FIG. 2A, in some operational scenarios, the plurality of candidate charging schedules may be generated by sliding or shifting a group of six (15-minute) intervals—representing candidate charging intervals during which the electric vehicle could be connected to and charged by the charging station with electricity drawn from the grid—from left to right, exploring the entire set of 15-minute intervals in the specific time window or available time.

In an example, respective total emissions for the plurality of candidate charging schedules may be first computed or estimated. As shown in FIG. 2A, a plurality of respective emissions including but not limited to E1, E2, E3 and E4 may be computed or estimated for the plurality of candidate charging schedules including but not limited to four candidate charging schedules in the four bottom rows. Each respective emission in the plurality of emissions may be computed or estimated by adding all (e.g., per-interval, possibly different, etc.) emissions that would be generated for all charging intervals in a respective candidate charging schedule in the plurality of candidate charging schedules. The respective total emissions may be compared. The candidate charging schedule with the lowest total emission among all the total emissions associated with (or computed for) the plurality of candidate charging schedules may be selected as the optimized charging schedule to carry out the actual charging of the electric vehicle with the charging station using electricity from the grid.

In another example, respective total utility costs/fees for the plurality of candidate charging schedules may be first computed or estimated. A plurality of respective utility costs/fees may be computed or estimated for the plurality of candidate charging schedules. Each respective utility cost/fee in the plurality of utility costs/fees may be computed or estimated by adding all (e.g., per-interval, possibly different, etc.) utility costs/fees that would be generated for all charging intervals in a respective candidate charging schedule in the plurality of candidate charging schedules. The respective total utility costs/fees may be compared. The candidate charging schedule with the lowest total utility cost/fee among all the total utility costs/fees associated with (or computed for) the plurality of candidate charging schedules may be selected as the optimized charging schedule to carry out the actual charging of the electric vehicle with the charging station using electricity from the grid.

In various operational scenarios, the optimized charging schedule can be selected from among the plurality of candidate charging schedules based on a combination of multiple factors including but not limited to emission, utility cost/fee, user preference(s), etc. For example, a total cost for a candidate charging schedule may be represented by an example Hamiltonian (e.g., a scalar expression, a vector expression, a tensor expression, etc.) specified as follows:

H=m1*(EnergyUsed×Emissions)+m2*(EnergyUsed×UtilityCost) (1)

where m1 and m2 represent weight factors; EnergyUsed represents energy (e.g., in unit of Kilowatt per hour, etc.) used in charging intervals of the candidate charging schedule; Emission represents greenhouse gas or carbon emission (e.g., in unit of gram of CO2, etc.) incurred for supplying electricity from the grid to the electric vehicle; UtilityCost represents costs or fees (e.g., in dollar, etc.) charged by the operator or owner of the grid for the supplied electricity to the electric vehicle.

Each of EnergyUsed, Emission and UtilityCost may be represented as a row or column vector comprising a plurality of vector components for a plurality of (component) energy used portions, emission portions or utility cost portions in a plurality of charging intervals constituting the candidate charging schedule. Each vector component in the plurality of vector components may store or cache a respective (component) energy used portion, emission portion or utility cost portion for a respective charging interval in the plurality of charging intervals of the candidate charging schedule. Additional terms or additional dimensions of the existing terms (e.g., relating to battery degradation, etc.) can be defined in a Hamiltonian as described herein (e.g., as shown in expression (1) above, etc.) to take into account of factors other than emission and utility cost/fee.

Some or all of the weight factors can be set, preconfigured, adaptively or dynamically or automatically configured, for example by the schedule generator in the system (102) and/or by the user/operator/owner. Some or all of these weight factors may be normalized or renormalized into a specific value range such as from zero (0) to one (1).

Some or all of the weight factors can be set based at least in part on user input, for example received from the user/operator/owner of the electric vehicle through user interface(s) such as input boxes, sliding scale controls, selection buttons, etc., supported or implemented with the system (102). In an example, the user may set a relatively high weight m1 for emission, relative to the weight m2 for utility cost, to indicate a bias or preference for reducing emissions associated with charging the electric vehicle. In another example, the user may set a relatively high weight m2 for utility cost, relative to the weight m1 for the emission, to indicate a bias or preference for reducing utility costs associated with charging the electric vehicle. In yet another example, the user may set comparable weights m1 and m2 for utility cost and emission, to indicate a combined goal of reducing the utility costs associated with charging the electric vehicle while reducing the emission.

3.5. Bidirectional Enerty/Power Transfer

Techniques as described herein can be implemented by the carbon footprint optimization system (102) to use vehicle batteries from the electric vehicles (108) to cover for home electricity demands as and when needed in the homes (124). The system (102) can implement (relatively comprehensive) optimization algorithms/methods/models to generate predictions of vehicle and home electricity demands and predictions of electricity demands and emissions at other levels such as grid or locality level and use these predictions to set up relatively smart schedules for operations such as charging, recharging and transferring electricity from, the vehicle batteries. By taking advantage of bidirectional energy/power transfer capabilities of (e.g., a proper subset in, etc.) the electric vehicles (108) and/or the homes (124) as permitted or indicated by their users/operators/owners/residents, the system (102) can use the vehicle batteries to support both the home electricity demands and vehicle electricity demands while at the same time to reduce overall carbon footprint.

FIG. 2B and FIG. 2C illustrate example optimization of charging schedules for meeting electricity demands of an electric vehicle and/or a home at which the electric vehicle is connected to a charging station for unidirectional and/or bidirectional energy/power transfers. In block 252, the system (102) or a schedule generator therein determines that the electric vehicle is (e.g., electrically, communicatively, etc.) connected to a charger or charging station at a home (or a dwelling/building). The schedule generator may be remote or local to the electric vehicle or the charging station at the home.

As noted, the system (102) or the electricity demand and carbon prediction models (112) therein can include one or more grid or locality level dynamic or static prediction models for determining or predicting estimations or forecasts of current or future utility rates for electricity and/or current or future emissions (e.g., rate of emission, carbon intensity, etc.) associated with producing electricity by a grid or in a locality where the electric vehicle can draw electricity from the charging station connected to the grid at the home. The system (102) or the electricity demand and carbon prediction models (112) therein can also include one or more personalized prediction models for determining or predicting personalized usage patterns associated with the electric vehicle. The grid or locality level and personalized prediction models can be trained dynamically and/or beforehand to use input features extracted from raw training data associated with the electric vehicle or a set or subset of electric vehicles including the electric vehicle. The system (102) or the electricity demand and carbon prediction models (112) therein can further include one or more second personalized prediction models for determining or predicting personalized usage patterns associated with the home. Some or all of these prediction models can be trained dynamically and/or beforehand to use input features extracted from training data (e.g., with labels or ground truths, etc.).

In response to determining—e.g., based on user input, based on estimation of available time, etc.—that the electric vehicle is to be charged immediately as the available time for charging is relatively short or inflexible, the system may operate to cause the electric vehicle to be charged immediately.

On the other hand, in response to determining—e.g., based on user input, based on estimation of the available time, etc.—that the electric vehicle does not have to be charged immediately as the available time for charging is relatively long or flexible, in block 254, the system (102) can select or identify the electric vehicle for charging event optimization. The system (102) can proceed to determine or select an optimization level from among a plurality of supported optimization levels. The determination or selection of the optimization level can be made based in part or in whole on user input. The determination or selection of the optimization level can also be made based in part or in whole on system settings including default settings that may be changeable by a user manually or by the system (102) automatically, or with interactions between the user and the system (102). Example optimization levels may include, but are not necessarily limited to only, any, some or all of: “non-optimized” charging, “smart” charging, 1 bidirectional slot, 2 bidirectional slots, etc.

In block 256, the system (102) can predict, identify or determine the available time as a specific time window to act as a (e.g., primary, constraining, etc.) placeholder for optimization. The specific time window represents a time duration during which the vehicle can be charged through the charging station at the home. The system (102) can further determine the specific electricity demand(s) of the electric vehicle and/or of the home, along with applicable grid or locality level utility rates for electricity and estimated or forecasted emissions associated with producing electricity in the specific time window. With all this information the schedule generator or an optimization algorithm/method used thereby starts optimizing for deriving a relatively smart schedule for charging, recharging and/or effectuating transferring energy/power to the home from, the electric vehicle in the available time.

In block 258, the system (102) generates a plurality of candidate (charging, recharging and/or bidirectional transferring) schedules each comprising charging intervals, recharging intervals and/or bidirectional intervals within the specific time window. As illustrated in FIG. 2C, the specific time window or available time may be divided with a number of non-overlapping consecutive (e.g., 15-minute, etc.) intervals or time blocks.

In block 260, the system (102) selects a specific candidate schedule from among the plurality of candidate schedules as an optimized (charging, recharging and/or bidirectional transferring) schedule for the electric vehicle and/or the home within the specific time window. The optimization algorithm can simulate all operations for charging, recharging and/or bidirectional energy/power transfers for each of the candidate schedules, compute or determine a respective emission associated with each such candidate schedule, compute or determine a respective utility cost or fee associated with each such candidate schedule, and so forth. Some or all of individual emissions and utility costs or fees respectively associated with the candidate schedules can be saved or cached in memory for comparison. The specific candidate schedule may correspond to a relatively low emission such as the lowest emission and/or a relatively low utility cost or fee such as the lowest utility cost or fee among a plurality of computed emissions and/or utility costs/fees respectively associated with the plurality of candidate schedules.

Hence, in some operational scenarios, in addition to optimizing schedules for charging operations of the electric vehicle based on the demand of the electric vehicle for vehicle propulsion and vehicle related functions, schedules for (additional) bidirectional energy/power transfer operations—including (1) recharging operations to draw extra electricity from the grid to the electric vehicle for eventual home electricity consumption and (2) (home bound) energy/power transferring operations to transfer the extra electricity from the electric vehicle to the home—can also be optimized.

The optimization of schedules for overall bi-directional energy/power operations that include both the charging operations and the recharging operations and the (home bound) energy/power transferring operations may be based on a number of operational and/or system parameters including not necessarily limited to only any, some or all of: electricity demand of the vehicle for its operations (e.g., for the next day, until the next charging event, etc.); battery chemistry (e.g., physical or chemical material types used for electrodes and/or electrolytes in batteries in the electric vehicle, nickel-manganese-cobalt or NMC batteries, lithium batteries, non-lithium batteries, lithium—sulfur or Li—S batteries, Lithium-sulfur-phosphorus or LSP batteries, Lithium tin phosphorus sulfide (LSPS) batteries, etc.); battery size of these batteries; the grid (e.g., energy source composition, emissions, utility costs/fees, etc.); electricity demand of the home for home operations (e.g., peak electricity usage, average electricity usage, time of the day, day of the week, seasonal pattern, etc.); and so on.

The optimization using bidirectional energy/power transfers herein can be extended beyond simply optimizing for vehicle operations to cover at least a part of electricity demand of the home demand.

By way of illustration only, a plurality of (e.g., consecutive, non-overlapping, etc.) time intervals in the entire specific time window or available time during which the electric vehicle is connected to the charging station of the home are ranked—by the system (102) or the schedule generator (e.g., local or remote to the electric vehicle, charging station or home, etc.)— based on individual (amounts of) greenhouse gas or CO2 emissions of the grid (e.g., per unit of energy/electricity used, overall energy/electricity used, etc.) forecasted or predicted or estimated respectively for these time intervals.

In addition, both time distributions of energy or electricity to be consumed by the home and the electric vehicle, respectively, can be forecasted, estimated, predicated or otherwise determined—by the system (102) or the schedule generator (e.g., local or remote to the electric vehicle, charging station or home, etc.)—for the purpose of carrying out the optimization.

For example, a first time distribution of energy or electricity to be consumed by the home may indicate home electricity usage or demand for each time interval in the plurality of time intervals constituting the specific time window or available time. A second time distribution of energy or electricity to be consumed by the electric vehicle may indicate electricity usage or demand for vehicle operations after the specific time window, for the next day, until the next charging time, etc.

Based on the second time distribution, a total amount of time—denoted as n (15-minute) time intervals, where n represents a positive integer no less than one (1)—used to charge the electric vehicle for vehicle operations can be estimated or determined by the system (102) or the schedule generator. This total amount of time is separate from (additional) time to be used for (additional) bidirectional energy/power transfer (also referred to as bidirectional charging).

Each candidate schedule in the plurality of candidate schedules is generated to fill the specific time window or available time with at least the n time intervals for charging the electric vehicle for its vehicle propulsion or vehicle related operations (unrelated to or separate from home electricity consumption).

In each candidate schedule, each time interval in the plurality of time intervals spanning the specific time window or available time may be classified into or designated with a specific operational type selected from among a plurality of (possible) operational types.

In some operational scenarios, the plurality of operational types includes four operational types as follows: (1) a first operational type (denoted as “C”), during a time interval of which a vehicle charging operation occurs (or is performed) to meet (e.g., a part of, etc.) electricity demand of the electric vehicle for vehicle propulsion and other vehicle related operations or functions; (2) a second operational type (denoted as “R”), during a time interval of which a vehicle recharging operation occurs (or is performed) to draw electricity from the grid for the purpose of meeting partial or whole electricity demand of the home in one or more other (e.g., subsequent to at least one “R” slot, subsequent to at least one “R” or “C” slot, etc.) time intervals in the specific time window or available time; (3) a third operational type (denoted as “B”), during a time interval of which electricity stored in the batteries of the electric vehicle is drawn through a (home bound) bidirectional energy/power transfer operation to supply or meet partial or whole electricity need or demand of the home in place or in addition to electricity drawn from the grid to the home; (4) a fourth operational type (denoted as “G”), during a time interval of which electricity is drawn from the grid to supply or meet partial or whole electricity need or demand of the home without electricity drawn from the batteries of the electric vehicle to the home; and so forth.

For the purpose of illustration only, it has been described that the specific time window or available time during which the electric vehicle is connected with the charging station at the home may be divided or partitioned into multiple 15-minute time intervals each of which may be classified into or assigned with a specific operational type. In various operational scenarios, different time lengths (e.g., 10 or 20 minutes instead of 15 minutes, etc) or amounts—e.g., in which the grid is relatively steady or stable—may be used for these time intervals. Additionally, optionally or alternatively, in some operational scenarios, constant and/or non-constant time intervals may be used to designate operational types.

As noted, the plurality of 15-minute time intervals in the entire specific time window or available time during which the electric vehicle is connected to the charging station of the home can be ranked based on the individual greenhouse gas or CO2 emissions of the grid forecasted or predicted or estimated respectively for these time intervals. As illustrated in FIG. 2C, each of the 15-minute intervals or slots is ranked based on the grid emissions during that time interval or slot, with the lowest rankings corresponding to the lowest emissions.

With these rankings of time intervals or slots, different levels or layers of optimization can be implemented possibly with varying amounts of bidirectional charging, in addition to or other than a “non-optimized” (or non-smart) level.

At the “non-optimized” level, the electric vehicle behaves with no or little intervention from the optimization algorithm or schedule generator in the system (102), not taking any emissions data into account. The electric vehicle is simply charged for the first n time intervals or slots (designated as “C”) in the specific time window or available time to reach a level sufficient to meet electricity demand of the electric vehicle for vehicle propulsion and vehicle related operations. This number n represents the electricity demand of the electric vehicle for its own use without considering electricity demand of the home and can be maintained or satisfied in all levels of optimizations. All other time intervals following or subsequent to the first n time intervals are of the “G” type.

For any of the different levels or layers of optimization other than the “non-optimized” level, an optimized schedule may be set up or generated by the system (102) or the schedule generator therein as a specific candidate schedule with a specific combination of operational types for all the time intervals within the specific time window or available time that is associated with (or would generate) the lowest emission among emissions associated with (or would be generated from) a plurality of candidate schedules with all possible combinations of operational types for all the time intervals within the specific time window or available time.

The different levels or layers of optimization as implemented by the system (102) or the schedule generator therein may include a “smart” (or vehicle optimized) level at which the n time intervals or slots are positioned or arranged within (e.g., six, etc.) time intervals of the lowest grid emissions as determined by the (emission) rankings. The rest of the time intervals with relatively high grid emissions are set as the “G” type. During these latter time intervals of the “G” type, the electric vehicle is not being charged and the home receives, draws or consumes power or electricity from the grid.

The different levels or layers of optimization as implemented by the system (102) or the schedule generator therein may include one or more optimization levels or layers that make use of bidirectional energy/power transfer.

For example, at a “1 BiDi slot” level or layer, a single (recharging) time interval or slot—starting from a currently still available time interval or slot of the lowest ranking, which in this example is the (n+1)-th ranking in emission—in the entire specific time window or available time may be classified or designated as the “R” type. In this single time interval or slot of the “R” type, the electric vehicle can be recharged (or charged) by electricity from the grid for storing energy in the batteries of the electric vehicle. The energy stored in the batteries of the electric vehicle can then be transferred from the batteries to the home in one or more time intervals or slots of the “B” type. The maximum amount of the energy recharged in the single time interval or slot of the “R” type can be estimated or calculated based on the maximum (electricity) charging rate supported by the charging station and/or the electric vehicle. Electricity usage or demands of the home in one or more time intervals other than the time intervals or slots already classified or designated as the “C” and/or “R” types may be estimated or summed into a total aggregated amount of energy until the (e.g., maximum, 95% maximum, etc.) amount of the (e.g., recharged, designated for bidirectional energy/power transfer, etc.) energy stored in the batteries is nearly exceeded by the total aggregated amount of energy summed from the electricity usage or demands of the home in the one or more time intervals, such that an addition of electricity usage or demand of the home in another or the next time interval or slot would cause the aggregated total to be over the (e.g., maximum, 95% maximum, etc.) amount of the (e.g., recharged, designated for bidirectional energy/power transfer, etc.) energy stored in the batteries. The one or more (“B”) time intervals designated for the home to receive energy or electricity from the batteries of the electric vehicles may be selected as those having the highest rankings in emissions from the remaining time intervals or slots other than the time intervals or slots already classified or designated as the “C” and/or “R” types.

In some operational scenarios, as the total amount of (e.g., actually consumed, etc.) energy or electricity demands of the home during the one or more (“B”) time intervals or slots may be lower than the total amount of energy generated through recharging the batteries of the electric vehicle from the grid, a new or different charging rate that is (e.g., slightly, by a relatively small safety margin, 5%, 10%, etc.) less than the maximum charging rate supported by the charging station and/or the electric vehicle may be calculated or actually used in the recharging operation in the recharging (“R”) time interval or slot for the purpose of not wasting or not using up the energy recharged and stored into the batteries of the electric vehicle. This can be accomplished by either reducing power output from the charger or charging station or by shortening the (e.g., duty, actual recharging or charging, etc.) time during which the electric vehicle is being charged or recharged by the charger or stations. The shortened time may be 10 min in the 15-minute (“R”) time interval or slot to obtain or receive ⅔ of the total maximum energy supported by the charger or charging station.

The foregoing operations for the “1 BiDi slot” optimization level may be (e.g., iteratively, recursively, etc.) repeated to add one recharging time interval or slot (also referred to as “bidirectional charging slot”) at a time, thereby achieving a higher optimization level than the “1 BiDi slot” optimization level such as a “2 BiDi slot” optimization level, a “3 BiDi slot” optimization level, etc., until no time intervals or slots remain in the default state or of the “G” type. Once no time intervals or slots remain in the default state or of the “G” type, any additional recharging time intervals or slots for further optimization may be less efficient than what has already been achieved in the preceding optimization(s).

The optimization level with no time intervals or slots remaining in the default state or of the “G” type corresponds to the maximum number of recharging time intervals or slots (or bidirectional slots). For the purpose of illustration only, as shown in FIG. 2C, in some operational scenarios, this maximum number may be two (2)—the corresponding optimization level may be labeled as “2 (Max) BiDi slot”. It should be noted that, in various operational scenarios, this maximum number may be one (1), two (2), three (3), and so on.

For the purpose of illustration only, it has been described that individual time intervals or slots in the specific time window or available time can be ranked with emissions generated from the producing of (e.g., grid supplied, etc.) electricity. It should be noted that, in some operational scenarios, individual time intervals or slots in the specific time window or available time can be ranked with utility costs/fees for consuming (e.g., grid supplied, etc.) electricity. Also, it should be noted that, in various operational scenarios, individual time intervals or slots in the specific time window or available time can be ranked with costs computed, through a Hamiltonian or another applicable functional form, based on a combination of factors including but not limited to emissions associated with or utility costs/fees for consuming (e.g., grid supplied, etc.) electricity.

Additionally, optionally or alternatively, at any given optimization level, an optimized schedule, whether involving bidirectional energy/power transfer or not, may be selected from among a plurality of candidate schedules based on costs computed, through a Hamiltonian or another applicable functional form, based on a combination of multiple factors including but not limited to emission, utility cost/fee, user preference(s), etc.

For example, for the purpose of generating an optimized schedule involving bidirectional transfer, a total cost for a candidate schedule composed of various operational types of time slots may be computed through an example Hamiltonian (expression) specified as follows:

H=m1*(EnergyUsed×Emissions)+m2*(EnergyUsed×UtilityCost)+Penalty(SoC) (2)

where Penalty( ) represents a penalty function. For the purpose of illustration only, the argument or input parameter to the penalty function may be the state of charge (SoC) of the batteries of the electric vehicle. It should be noted that, in various operational scenarios, a penalty function as described herein may depend on one or more other arguments, input parameters, etc., in addition to or in place of the SoC.

In some operational scenarios, a (component) penalty value generated from the penalty function and added to the (Hamiltonian) cost for a specific time interval in a specific candidate schedule for charging, recharging and/or home bound energy/electricity transfer from the batteries of the electric vehicle may be dependent on one or more states, arguments, input parameters, etc., such as the SoC applicable to or updated for the specific time interval.

By way of illustration but not limitation, in the example as illustrated in FIG. 2C, n+2 time intervals may be used for charging or recharging at the “2 (max) BiDi slot” optimization level. Each candidate schedule (in a plurality of candidate schedules) represented by a respective combination (in a plurality of combinations) of n charging time intervals and 2 recharging time intervals and the remaining “B” time intervals in the specific time window or available time may be evaluated with a total Hamiltonian cost computed based on expression (2) above. A plurality of total Hamiltonian costs respectively for the plurality of candidate schedules can thus be generated and compared to determine or select an optimized schedule as corresponding to a specific candidate schedule, among the plurality of candidate schedules, with the lowest total Hamiltonian cost among the plurality of total Hamiltonian costs.

3.6. Penalty Functions

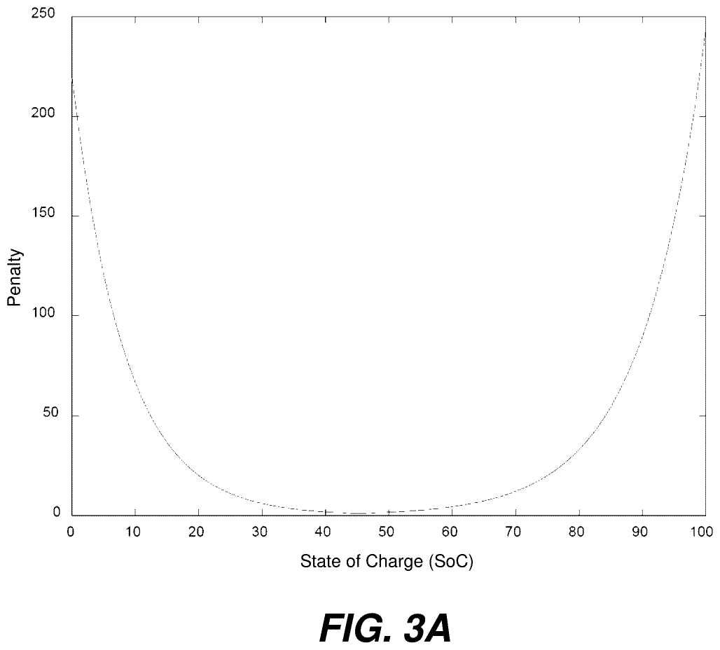

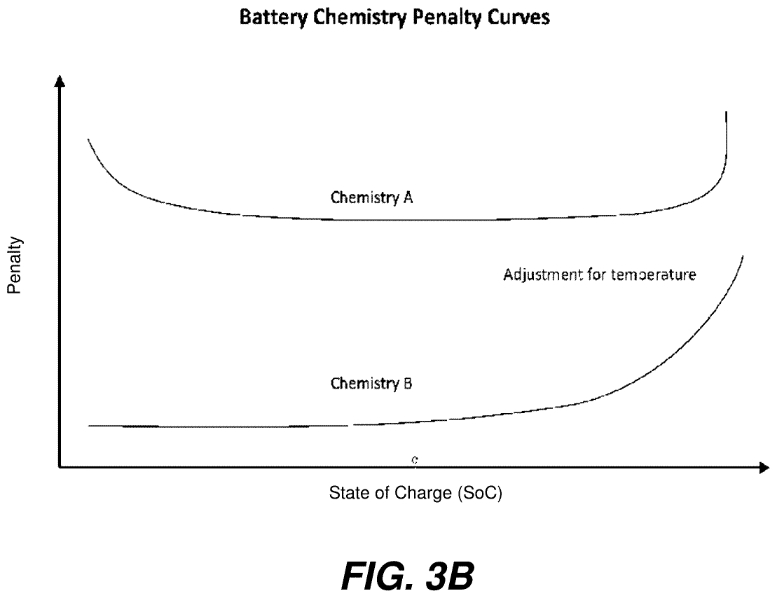

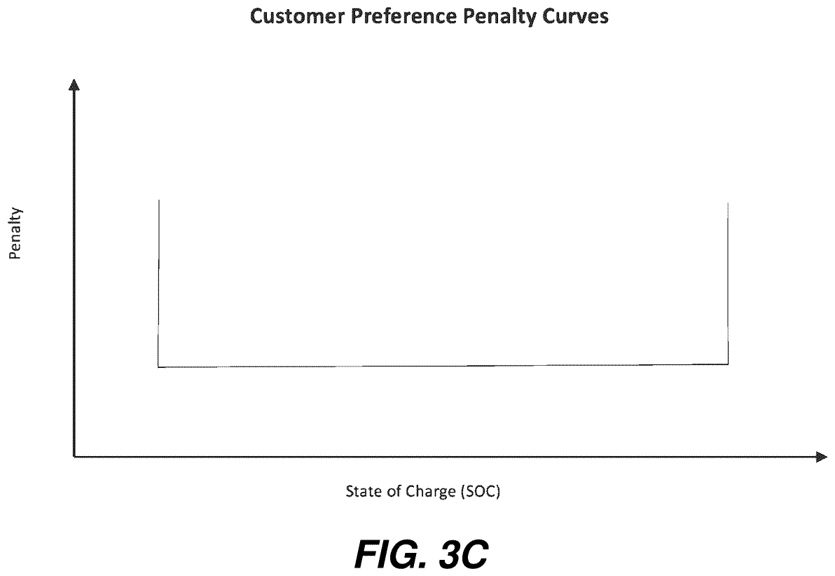

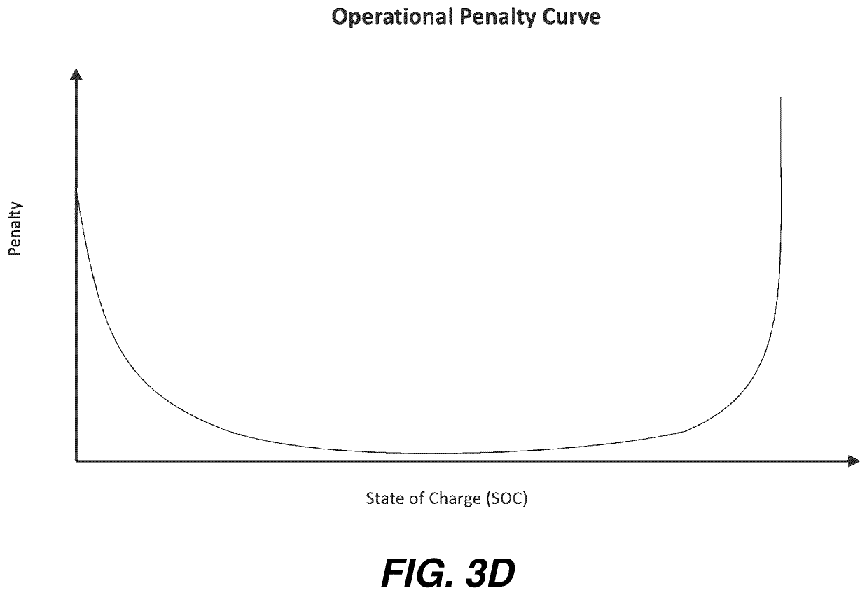

FIG. 3A illustrates an example state of charge (SOC) dependent penalty function that may be used in a Hamiltonian such as illustrated in expression (2) above. The penalty, represented by y-axis, is a function of the SOC of the batteries, whereas argument(s) or input parameter(s), represented by x-axis, can be used to influence the penalty or the Hamiltonian to account for factors such as battery chemistry, battery temperature, customer preference, operational factors, etc.

As the SOC may be derived or specified as a function of (electric) voltage, the penalty function can be used to prioritize (with relatively low penalty values) battery operations such as energy transfers within specific voltage range(s) and to discourage (with relatively high penalty values) such battery operations outside these voltage range(s). As a result, risk for degrading the batteries at extreme voltages can be reduced or avoided by providing a slope that is commensurate with or scales with the risk. Additionally, optionally or alternatively, the penalty function can evolve or vary over the lifetime of the batteries or the electric vehicle by taking into account calendric or other degradations of the batteries and changing performance characteristics of the batteries or the electric vehicles over time. Such degradations of the batteries and changing performance characteristics may be estimated or evaluated based at least in part on the state of health (SOH) computed based on a variety of battery characteristics or performance measurements (e.g., taken during charging, recharging, energy transferring, vehicle operations, etc.).

FIG. 3B illustrates example battery chemistry dependent (as well as SOC dependent) penalty functions that may be used in a Hamiltonian such as illustrated in expression (2) above. As shown, the upper penalty function may correspond to a first battery chemistry type, whereas the lower penalty function may correspond to a second different battery chemistry type. Battery chemistry or battery chemistry type may refer to different physical and/or chemical materials or compositions thereof used for the anode, cathode, and electrolyte of the electric batteries of the electric vehicle.

The battery temperature may also be used as a factor in the penalty function. Since the battery performance characteristics are influenced by the battery temperature, the penalty function can be used to steer battery usage or operation such as (home bound) energy transfers in the range of SOC that is relatively safe or the safest for a given operational temperature.

FIG. 3C illustrates an example penalty function, with hard cutoff(s), that may be used in a Hamiltonian such as illustrated in expression (2) above. For example, the penalty function may be derived at least in part from customer preferences such as range anxiety. Hard cutoffs may be applied at a lower limit of the SOC to account for a minimum range that is always kept in reserve for the customer or user of the electric vehicle. For example, if the customer's daily commute is 30 miles from home, and if the electric vehicle has a 200 mile total range, then a hard cut-off for the customer preferences may be set at 15% of the SOC to provide a reserve range of 30 miles. Similar reserves for customer preferences may be established for an upper limit of the SOC of the batteries to account for available or potential storage for opportunistic charging with solar energy or low-cost energy from the grid or for excluding the risk of battery overcharging. Additionally, optionally or alternatively, the upper limit (e.g., 95%, etc.) may be set in order to lengthen operational lives of the batteries or prevent battery degradation.

FIG. 3D illustrates an example penalty function, to account for one or more operational factors, that may be used in a Hamiltonian such as illustrated in expression (2) above. The penalty function may be influenced by these operational factors imposed for or used by operational or optimization algorithms that operate in conjunction with the batteries and/or the electric vehicle and/or the system (102). These operational factors may, but are not limited to, be used to generate or specify an asymptotic curve to establish or enforce boundary conditions in the (low and high) extreme ranges of the SOC of the batteries.

3.7. Visualizing Emissions and Demands

The UIs (110) in or operating in conjunction with the system (102) may be used to convey emissions and electricity demands tracked, determined, estimated, predicted and/or forecasted by the system (102) to operators of the grid(s), users/operators of the electric vehicles (108), and/or users/residents of the homes (124). The UIs (110) may be designed with a human response model applicable to (e.g., specific, most, average, etc.) grid operators and/or drivers/owners of the electric vehicles and/or users/residents of the homes.

FIG. 2D illustrates an example display page (or heat map) that visualizes emissions and electricity demands over every (e.g., color coded based on carbon intensity, etc.) block of one hour during a time period of two months. For example, the display page may be used to convey or report to a driver/owner of an electric vehicle or a user/resident of a home as to different levels of carbon intensities—or intensities of emissions—from different mixes or combinations of energy source types in different hours representing by different color coded blocks. The display page may also be used to indicate specific blocks in which the electric vehicle has been scheduled (e.g., with optimization, without optimization, etc.) for charging, recharging or electricity transferring during the time period represented by the specific blocks. The display page may further be used to indicate specific blocks in which the electric vehicle has not been scheduled for charging, recharging or electricity transferring.

Likewise, display pages can be used to convey or report to operators of the grid(s) information about emissions or demands as tracked, determined, estimated, predicted and/or forecasted by the system (102).

Additionally, optionally or alternatively, trends in emissions or electricity demands can be tracked, determined, estimated, predicted and/or forecasted by the system (102) and displayed in the UIs (110) for planning purposes.

In addition to enabling charging, recharging or electricity transferring to or from electric vehicles with energies or energy sources that generate minimized emissions, the UIs (110) can be used to influence customer or human behaviors to change vehicle or home operation or usage patterns, and to use more renewable or low emission energies and energy sources as compared with other energies or energy sources given the same or comparable costs for electricity. For example, some customers can opt out and choose to charge or recharge their electric vehicles immediately or at customer-set times (e.g., 9 pm in the evening, etc.) for charging or recharging events without being optimized. Some customers can opt out and choose not to transfer electricity from their electric vehicles to homes. Additionally, optionally or alternatively, some customers may choose to override optimized charging, recharging or electricity transferring schedules that have been presented to them for charging, recharging or electricity transferring to or from their electric vehicles. The UI(s) can be used to show gas emissions associated with optimized events/schedules and/or with non-optimized events/schedules for the same customers or among different customers of the same electricity grid.

### 4.0. Example Process Flows

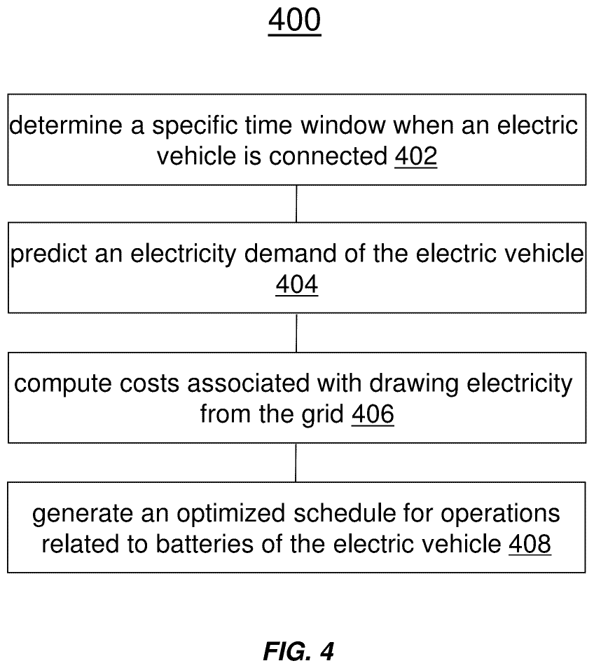

FIG. 4 illustrates an example process flow 400 according to an embodiment. In some embodiments, one or more computing devices or components may perform this process flow. In block 402, a system as described herein determines a specific time window during which an electric vehicle is connecting with a charging station. The charging station is connected with a grid from which the charging station is configured to draw electricity to charge the electric vehicle.

In block 404, the system predicts an electricity demand of the electric vehicle based on a current state of charge (SoC) of one or more batteries of the electric vehicle;

In block 406, the system computes one or more costs associated with drawing electricity from the grid during one or more time intervals, wherein the specific time window is partitioned into a plurality of consecutive non-overlapping time intervals that include the one or more time intervals;

In block 408, the system generates, based at least in part on the one or more costs, an optimized schedule for performing a set of operations with the one or more batteries of the electric vehicle, wherein the set of operations include at least a subset of operations used to charge the electric vehicle to satisfy the predicted electricity demand of the electric vehicle.

In an embodiment, each of the one or more costs is generated using a Hamiltonian expression that is dependent on one or more of: a greenhouse gas emission cost associated with producing electricity during at least one of the one or more time intervals in the specific time window; a utility cost for electricity charged by an operator in connection with electricity consumption in at least one of the one or more time intervals; a penalty that depends at least in part on one or more penalty cost factors relating to one of: the batteries of the electric vehicle or user preferences; etc.

In an embodiment, the one or more penalty cost factors include one or more of: the SoC of the one or more batteries of the electric vehicle; battery chemistry of the one or more batteries of the electric vehicle; a state of health (SoH) of the one or more batteries of the electric vehicle; one or more operational temperatures of the one or more batteries of the electric vehicle; a minimum range preference specified for the electric vehicle; an upper limit preference specified for the one or more batteries of the electric vehicle; etc.

In an embodiment, the charging station is located at a home; a second electricity demand of the home during the specific time window is predicted; the optimized schedule is generated further based on the second electricity demand of the home; the set of operations specified in the optimized schedule includes operations to charge the batteries of the electric vehicle for satisfying the predicted electricity demand of the electric vehicle in one or more first time intervals in the specific time window, to recharge the batteries of the electric vehicle, in one or more second time intervals in the specific time window, for storing energy to be transferred to the home, and to transfer the energy stored in the batteries of the electric vehicle to the home for satisfying at least a portion of the predicted second electricity demand of the home; etc.

In an embodiment, a plurality of costs is generated for the plurality of consecutive non-overlapping time intervals; each cost in the plurality of costs is generated for a respective time interval in the plurality of consecutive non-overlapping time intervals.

In an embodiment, the subset of operations used to charge the electric vehicle to satisfy the predicted electricity demand of the electric vehicle is scheduled to be performed in a subset of time intervals, corresponding to the lowest costs among the plurality of costs, in the plurality of consecutive non-overlapping time intervals.

In an embodiment, the optimized schedule is generated for a specific optimization level among a plurality of optimization levels in addition to a non-optimized level; the plurality of optimization levels includes one or more of: a first optimization level in which only the electricity demand of the electric vehicle is satisfied, a second optimization level in which a single recharging time interval, among the plurality of consecutive non-overlapping time intervals, is used to store energy in the batteries of the electric vehicle for transferring to the home, one or more third optimization levels in which multiple recharging time intervals, among the plurality of consecutive non-overlapping time intervals, are used to store energy in the batteries of the electric vehicle for transferring to the home; etc.

In an embodiment, the optimized schedule includes only a combination of one or more charging time intervals during which the batteries of the electric vehicle are charged to satisfy the predicted electricity demand of the electric vehicle; one or more recharging time intervals during which the batteries of the electric vehicle are charged to store energy in the batteries of the electric vehicle to be transferred to the home; and one or more home bound energy transfer time intervals during which the stored energy in the batteries of the electric vehicle is transferred to the home to satisfy at least a portion of the predicted second electricity demand of the home.

In an embodiment, the specific time window represents one of: a single contiguous time duration, or two or more discontinuous time durations separated by intermediate time durations excluded from the specific time window.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 5.0 Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

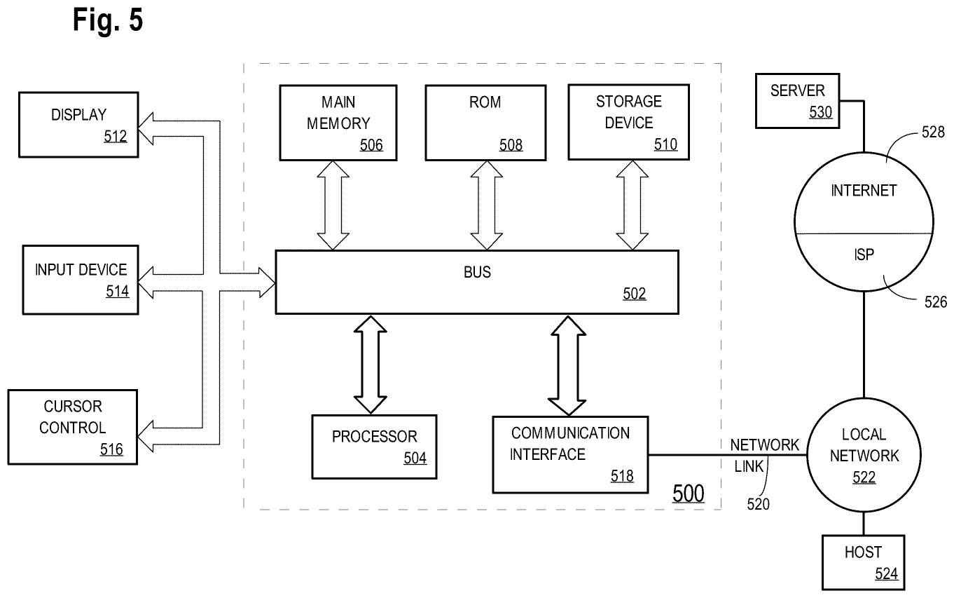

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the disclosure have been described with reference to numerous specific details that may vary from implementation to implementation. Thus, the sole and exclusive indicator of what is the disclosure, and is intended by the applicants to be the disclosure, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
determining a specific time window during which an electric vehicle is connecting with a charging station, wherein the charging station is configured to draw electricity from a grid to charge the electric vehicle;
predicting an electricity demand of the electric vehicle based on a current state of charge (SoC) of one or more batteries of the electric vehicle;
computing one or more costs associated with drawing electricity from the grid during one or more time intervals, wherein the specific time window is partitioned into a plurality of consecutive non-overlapping time intervals that include the one or more time intervals;
generating, based at least in part on the one or more costs, an optimized schedule for performing a set of operations with the one or more batteries of the electric vehicle, wherein the set of operations include at least a subset of operations used to charge the electric vehicle to satisfy the predicted electricity demand of the electric vehicle.

2. The method of claim 1, wherein each of the one or more costs is generated using a Hamiltonian expression that is dependent on one or more of: a greenhouse gas emission cost associated with producing electricity during at least one of the one or more time intervals in the specific time window; a utility cost for electricity charged by an operator in connection with electricity consumption in at least one of the one or more time intervals; or a penalty that depends at least in part on one or more penalty cost factors relating to one of: the batteries of the electric vehicle or user preferences.

3. The method of claim 2, wherein the one or more penalty cost factors include one or more of: the SoC of the one or more batteries of the electric vehicle; battery chemistry of the one or more batteries of the electric vehicle; a state of health (SoH) of the one or more batteries of the electric vehicle; one or more operational temperatures of the one or more batteries of the electric vehicle; a minimum range preference specified for the electric vehicle; or an upper limit preference specified for the one or more batteries of the electric vehicle.

4. The method of claim 1, wherein the charging station is located at a home; wherein a second electricity demand of the home during the specific time window is predicted; wherein the optimized schedule is generated further based on the second electricity demand of the home; wherein the set of operations specified in the optimized schedule includes operations to charge the batteries of the electric vehicle for satisfying the predicted electricity demand of the electric vehicle in one or more first time intervals in the specific time window, to recharge the batteries of the electric vehicle, in one or more second time intervals in the specific time window, for storing energy to be transferred to the home, and to transfer the energy stored in the batteries of the electric vehicle to the home for satisfying at least a portion of the predicted second electricity demand of the home.

5. The method of claim 1, wherein a plurality of costs is generated for the plurality of consecutive non-overlapping time intervals; wherein each cost in the plurality of costs is generated for a respective time interval in the plurality of consecutive non-overlapping time intervals.

6. The method of claim 5, wherein the subset of operations used to charge the electric vehicle to satisfy the predicted electricity demand of the electric vehicle is scheduled to be performed in a subset of time intervals, corresponding to the lowest costs among the plurality of costs, in the plurality of consecutive non-overlapping time intervals.

7. The method of claim 1, wherein the optimized schedule is generated for a specific optimization level among a plurality of optimization levels in addition to a non-optimized level; wherein the plurality of optimization levels includes one or more of: a first optimization level in which only the electricity demand of the electric vehicle is satisfied, a second optimization level in which a single recharging time interval, among the plurality of consecutive non-overlapping time intervals, is used to store energy in the batteries of the electric vehicle for transferring to the home, or one or more third optimization levels in which multiple recharging time intervals, among the plurality of consecutive non-overlapping time intervals, are used to store energy in the batteries of the electric vehicle for transferring to the home.

8. The method of claim 1, wherein the optimized schedule includes only a combination of one or more charging time intervals during which the batteries of the electric vehicle are charged to satisfy the predicted electricity demand of the electric vehicle; one or more recharging time intervals during which the batteries of the electric vehicle are charged to store energy in the batteries of the electric vehicle to be transferred to the home; and one or more home bound energy transfer time intervals during which the stored energy in the batteries of the electric vehicle is transferred to the home to satisfy at least a portion of the predicted second electricity demand of the home.

9. The method of claim 1, wherein the specific time window represents one of: a single contiguous time duration, or two or more discontinuous time durations separated by intermediate time durations excluded from the specific time window.

10. One or more non-transitory computer readable media storing a program of instructions that is executable by one or more computing processors to perform:
determining a specific time window during which an electric vehicle is connecting with a charging station, wherein the charging station is connected with a grid from which the charging station is configured to draw electricity to charge the electric vehicle;
predicting an electricity demand of the electric vehicle based on a current state of charge (SoC) of one or more batteries of the electric vehicle;
computing one or more costs associated with drawing electricity from the grid during one or more time intervals, wherein the specific time window is partitioned into a plurality of consecutive non-overlapping time intervals that include the one or more time intervals;
generating, based at least in part on the one or more costs, an optimized schedule for performing a set of operations with the one or more batteries of the electric vehicle, wherein the set of operations include at least a subset of operations used to charge the electric vehicle to satisfy the predicted electricity demand of the electric vehicle.

11. The media of claim 10, wherein each of the one or more costs is generated using a Hamiltonian expression that is dependent on one or more of: a greenhouse gas emission cost associated with producing electricity during at least one of the one or more time intervals in the specific time window; a utility cost for electricity charged by an operator in connection with electricity consumption in at least one of the one or more time intervals; or a penalty that depends at least in part on one or more penalty cost factors relating to one of: the batteries of the electric vehicle or user preferences.

12. The media of claim 11, wherein the one or more penalty cost factors include one or more of: the SoC of the one or more batteries of the electric vehicle; battery chemistry of the one or more batteries of the electric vehicle; a state of health (SoH) of the one or more batteries of the electric vehicle; one or more operational temperatures of the one or more batteries of the electric vehicle; a minimum range preference specified for the electric vehicle; or an upper limit preference specified for the one or more batteries of the electric vehicle.

13. The media of claim 10, wherein the charging station is located at a home; wherein a second electricity demand of the home during the specific time window is predicted; wherein the optimized schedule is generated further based on the second electricity demand of the home; wherein the set of operations specified in the optimized schedule includes operations to charge the batteries of the electric vehicle for satisfying the predicted electricity demand of the electric vehicle in one or more first time intervals in the specific time window; to recharge the batteries of the electric vehicle, in one or more second time intervals in the specific time window, for storing energy to be transferred to the home; and to transfer the energy stored in the batteries of the electric vehicle to the home for satisfying at least a portion of the predicted second electricity demand of the home.

14. The media of claim 10, wherein a plurality of costs is generated for the plurality of consecutive non-overlapping time intervals; wherein each cost in the plurality of costs is generated for a respective time interval in the plurality of consecutive non-overlapping time intervals.

15. The media of claim 14, wherein the subset of operations used to charge the electric vehicle to satisfy the predicted electricity demand of the electric vehicle is scheduled to be performed in a subset of time intervals, corresponding to the lowest costs among the plurality of costs, in the plurality of consecutive non-overlapping time intervals.

16. The media of claim 10, wherein the optimized schedule is generated for a specific optimization level among a plurality of optimization levels in addition to a non-optimized level; wherein the plurality of optimization levels includes one or more of: a first optimization level in which only the electricity demand of the electric vehicle is satisfied; a second optimization level in which a single recharging time interval, among the plurality of consecutive non-overlapping time intervals, is used to store energy in the batteries of the electric vehicle for transferring to the home; or one or more third optimization levels in which multiple recharging time intervals, among the plurality of consecutive non-overlapping time intervals, is used to store energy in the batteries of the electric vehicle for transferring to the home.

17. The media of claim 10, wherein the optimized schedule includes only a combination of one or more charging time intervals during which the batteries of the electric vehicle are charged to satisfy the predicted electricity demand of the electric vehicle; one or more recharging time intervals during which the batteries of the electric vehicle are charged to store energy in the batteries of the electric vehicle to be transferred to the home; and one or more home bound energy transfer time intervals during which the stored energy in the batteries of the electric vehicle is transferred to the home to satisfy at least a portion of the predicted second electricity demand of the home.

18. The media of claim 10, wherein the specific time window represents one of: a single contiguous time duration, or two or more discontinuous time durations separated by intermediate time durations excluded from the specific time window.

19. A system, comprising: one or more computing processors; one or more non-transitory computer readable media storing a program of instructions that is executable by the one or more computing processors to perform:
determining a specific time window during which an electric vehicle is connecting with a charging station, wherein the charging station is connected with a grid from which the charging station is configured to draw electricity to charge the electric vehicle;
predicting an electricity demand of the electric vehicle based on a current state of charge (SoC) of one or more batteries of the electric vehicle;
computing one or more costs associated with drawing electricity from the grid during one or more time intervals, wherein the specific time window is partitioned into a plurality of consecutive non-overlapping time intervals that include the one or more time intervals;
generating, based at least in part on the one or more costs, an optimized schedule for performing a set of operations with the one or more batteries of the electric vehicle, wherein the set of operations include at least a subset of operations used to charge the electric vehicle to satisfy the predicted electricity demand of the electric vehicle.

20. The system of claim 19, wherein each of the one or more costs is generated using a Hamiltonian expression that is dependent on one or more of: a greenhouse gas emission cost associated with producing electricity during at least one of the one or more time intervals in the specific time window; a utility cost for electricity charged by an operator in connection with electricity consumption in at least one of the one or more time intervals; or a penalty that depends at least in part on one or more penalty cost factors relating to one of: the batteries of the electric vehicle or user preferences.

21. The system of claim 20, wherein the one or more penalty cost factors include one or more of: the SoC of the one or more batteries of the electric vehicle; battery chemistry of the one or more batteries of the electric vehicle; a state of health (SoH) of the one or more batteries of the electric vehicle; one or more operational temperatures of the one or more batteries of the electric vehicle; a minimum range preference specified for the electric vehicle; or an upper limit preference specified for the one or more batteries of the electric vehicle.

22. The system of claim 19, wherein the charging station is located at a home; wherein a second electricity demand of the home during the specific time window is predicted; wherein the optimized schedule is generated further based on the second electricity demand of the home; wherein the set of operations specified in the optimized schedule includes operations to charge the batteries of the electric vehicle for satisfying the predicted electricity demand of the electric vehicle in one or more first time intervals in the specific time window; to recharge the batteries of the electric vehicle, in one or more second time intervals in the specific time window, for storing energy to be transferred to the home; and to transfer the energy stored in the batteries of the electric vehicle to the home for satisfying at least a portion of the predicted second electricity demand of the home.

23. The system of claim 19, wherein a plurality of costs is generated for the plurality of consecutive non-overlapping time intervals; wherein each cost in the plurality of costs is generated for a respective time interval in the plurality of consecutive non-overlapping time intervals.

24. The system of claim 23, wherein the subset of operations used to charge the electric vehicle to satisfy the predicted electricity demand of the electric vehicle is scheduled to be performed in a subset of time intervals, corresponding to the lowest costs among the plurality of costs, in the plurality of consecutive non-overlapping time intervals.

25. The system of claim 19, wherein the optimized schedule is generated for a specific optimization level among a plurality of optimization levels in addition to a non-optimized level; wherein the plurality of optimization levels includes one or more of: a first optimization level in which only the electricity demand of the electric vehicle is satisfied; a second optimization level in which a single recharging time interval, among the plurality of consecutive non-overlapping time intervals, is used to store energy in the batteries of the electric vehicle for transferring to the home; or one or more third optimization levels in which multiple recharging time intervals, among the plurality of consecutive non-overlapping time intervals, is used to store energy in the batteries of the electric vehicle for transferring to the home.

26. The system of claim 19, wherein the optimized schedule includes only a combination of one or more charging time intervals during which the batteries of the electric vehicle are charged to satisfy the predicted electricity demand of the electric vehicle; one or more recharging time intervals during which the batteries of the electric vehicle are charged to store energy in the batteries of the electric vehicle to be transferred to the home; and one or more home bound energy transfer time intervals during which the stored energy in the batteries of the electric vehicle is transferred to the home to satisfy at least a portion of the predicted second electricity demand of the home.

27. The system of claim 19, wherein the specific time window represents one of: a single contiguous time duration, or two or more discontinuous time durations separated by intermediate time durations excluded from the specific time window.
